(19) United States
(12) Patent Application Publication
(10) Pub. No.: US 2015/0011204 A1
(43) Pub. Date: Jan. 8, 2015

(54) MOBILE TERMINAL AND METHOD OF CONTROLLING THE MOBILE TERMINAL

(71) Applicant: LG ELECTRONICS INC., Seoul (KR)

(72) Inventors: Hyewon SEO, Seoul (KR); Hochan SONG, Seoul (KR); Hoonju YUN, Seoul (KR); Yeomyung YOON, Seoul (KR); Kyehwan LEE, Seoul (KR); Hanl PARK, Seoul (KR); Gukchan LIM, Seoul (KR); Seonhui KIM, Seoul (KR)

(73) Assignee: LG ELECTRONICS INC., Seoul (KR)

(21) Appl. No.: 14/174,479

(22) Filed: Feb. 6, 2014

(30) Foreign Application Priority Data
Jul. 4, 2013 (KR) 10-2013-0078488

(51) Int. Cl. H04W 4/00; H04W 8/18

(52) U.S. Cl. CPC H04W 4/003; H04W 8/183
USPC 455/419

(57) ABSTRACT

A mobile terminal including a wireless communication unit configured to perform wireless communication; a display unit configured to display information; and a controller that executes an agent to extract and record information about a usage pattern of a user, and displays an icon corresponding to the executed agent differently based on a number of times information related to the executed agent is extracted.

### CROSS-REFERENCE TO A RELATED APPLICATION

Pursuant to 35 U.S.C. §119(a), this application claims the benefit of earlier filing date and right of priority to Korean Application No. 10-2013-0078488, filed on Jul. 4, 2013, the contents of which is incorporated by reference herein in its entirety.

### BACKGROUND OF THE INVENTION

1. Field of the Invention

The present invention relates to a mobile terminal and more particularly to a mobile terminal equipped with an agent and a method of controlling the mobile terminal.

2. Background of the Invention

Terminals may be divided into mobile/portable terminals and stationary terminals. Also, the mobile terminals may be classified into handheld terminals and vehicle mounted terminals.

As the terminal becomes multifunctional, a mobile terminal can capture still images or moving images, play music or video files, play games, receive broadcast and the like, so as to be implemented as an integrated multimedia player.

There is an increasing need for an agent that manages all or some functions of the mobile terminal. However, the existing agent manages the mobile terminal indiscriminately without considering a user's usage pattern and the like. In addition, the existing agent manages only some limited functions.

### SUMMARY OF THE INVENTION

Therefore, an aspect of the detailed description is to provide a mobile terminal equipped with an agent tailed-made for a user, which is capable of improving user convenience and a method of controlling the mobile terminal.

To achieve these and other advantages and in accordance with the purpose of this specification, as embodied and broadly described herein, there is provided a mobile terminal including a controller that includes at least one or more agents, each extracting information including a user usage pattern associated with a pre-set key word from a usage record data on the mobile terminal, and a display unit to which an icon corresponding to each of the agents is output differently depending on the number of times that information relating to each of the agents is extracted, in which wherein the agent performs control so that an object corresponding to the information extracted by the agent is output to the display unit and thus the agent deletes one item of information selected from among the items of information extracted by the agent or adds newly-input information.

In the mobile terminal, the agent may control the display unit so that the icon corresponding to the agent is output on a background image corresponding to a current location of the mobile terminal.

In the mobile terminal, when the usage record data that is previously connected to an external device at the current location is present, the agent may control the display unit so that an object corresponding to the external device is output on the background image corresponding to the current location.

In the mobile terminal, the agent may control the display unit so that the icon corresponding to the agent is output by inputting a pre-set control command.

In the mobile terminal, the agent may transmit only the information selected from among the items of information extracted by the agent to an external device that is connected to the mobile terminal.

In the mobile terminal, the agent may be categorized into multiple levels, depending on the number of times that the related information is extracted, and may transmit only information corresponding to at least one level selected from among the multiple levels to the external device that is connected to the mobile terminal.

To achieve these and other advantages and in accordance with the purpose of this specification, as embodied and broadly described herein, there is provided a method of controlling a mobile terminal, the method including extracting information including a user's usage pattern associated with pre-set multiple key words from usage record data on the mobile terminal, displaying an icon corresponding to each of the multiple key words differently on the display unit, depending on the number of times that information relating to each of the multiple key words is extracted, outputting an object corresponding to the extracted information to the display unit, and editing the information relating to each of the multiple key words by deleting one item of information selected from among the extracted items of information or by adding newly-input information.

In the method, the displaying of the icon may include outputting the icon on a background image corresponding to a current location of the mobile terminal.

In the method, the outputting of the object may include outputting an object corresponding to an external device to the background image corresponding to the current location when the usage record data that is previously connected to the external device at the current location is present.

In the method, the displaying of the icon may include outputting the icon by inputting a pre-set control command.

The method may further include transmitting only information selected from among the extracted items of information to an external device that is connected to the mobile terminal.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a block diagram illustrating a mobile terminal according to an embodiment described in the present invention;

FIG. 2A and FIG. 2B are diagrams, each illustrating a telecommunication system in which the mobile terminal according to the present invention operates;

FIG. 3(a) is a perspective diagram illustrating the mobile terminal according to an embodiment of the present invention when viewed from the front, and FIG. 3(b) is a perspective diagram illustrating the mobile terminal in FIG. 3A when viewed from the rear;

FIG. 4 is a flowchart illustrating an embodiment of the mobile terminal according to the present invention;

FIGS. 5(a) and 5(b) are diagrams illustrating an embodiment of a user interface associated with a message reception agent.

FIGS. 6(a) to 6(c) are diagrams illustrating an embodiment of the user interface associated with an icon corresponding to the agent;

FIGS. 7A(a) to 7A(d) are diagrams illustrating an embodiment of a background image to which the icon corresponding to the agent is output;

FIGS. 7B(a) and 7B(b) are diagrams illustrating an embodiment in which the icon of the agent according to the background image grows;

FIGS. 7C(a) to 7C(c) are diagrams illustrating an embodiment indicating a place detected by the agent as an icon of the background;

FIGS. 8(a) and 8(b) are diagrams illustrating an embodiment of the user interface in which an object corresponding to an external device is output;

FIGS. 9(a) to 9(c) are diagrams illustrating an embodiment of the user interface in which an object corresponding to the information extracted by the agent is output;

FIGS. 10A(a) to 10F and FIGS. 11A(a) to 11D are diagrams illustrating an embodiment of the user interface associated with the icon corresponding to the agent;

FIGS. 12(a) to 12(d) are diagrams illustrating an embodiment of the user interface in which the extracted information is edited; and

FIGS. 13(a) to 13(c) are diagrams illustrating an embodiment of the user interface associated with the agent that is present in the external device.

### DETAILED DESCRIPTION OF THE INVENTION

Description will now be given in detail according to the exemplary embodiments, with reference to the accompanying drawings. For the sake of brief description with reference to the drawings, the same or equivalent components will be provided with the same reference numbers, and description thereof will not be repeated. A suffix “module” or “unit” used for constituent elements disclosed in the following description is merely intended for easy description of the specification, and the suffix itself does not give any special meaning or function. In describing the present invention, if a detailed explanation for a related known function or construction is considered to unnecessarily divert the gist of the present invention, such explanation has been omitted but would be understood by those skilled in the art. The accompanying drawings are used to help easily understood the technical idea of the present invention and is not limited by the accompanying drawings.

Mobile terminals described herein may include cellular phones, smart phones, laptop computers, digital broadcasting terminals, personal digital assistants (PDAs), portable multimedia players (PMPs), navigators, slate PCs, tablet PC, ultra books and the like. However, it may be easily understood by those skilled in the art that the configuration according to the exemplary embodiments of this specification can be applied to stationary terminals such as digital TV, desktop computers and the like excluding a case of being applicable only to the mobile terminals.

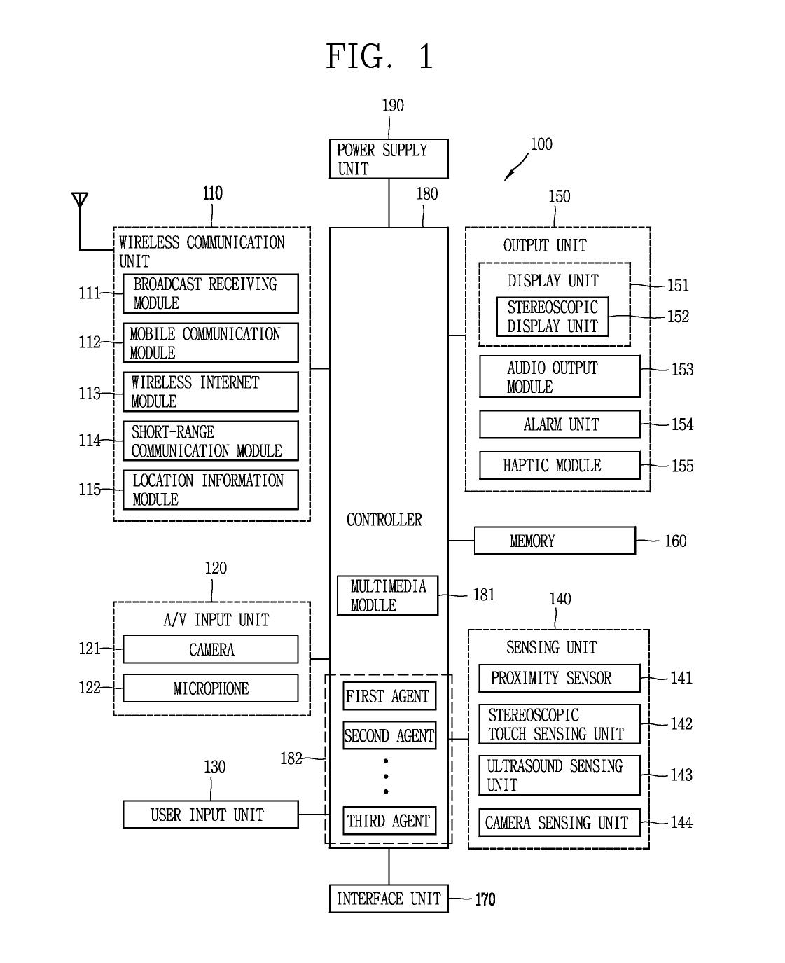

FIG. 1 is a block diagram of a mobile terminal 100 in accordance with one exemplary embodiment. The mobile terminal 100 may include components, such as a wireless communication unit 110, an Audio/Video (A/V) input unit 120, a user input unit 130, a sensing unit 140, an output unit 150, a memory 160, an interface unit 170, a controller 180, a power supply 190 and the like. FIG. 1 shows the mobile terminal 100 having various components, but implementing all of the illustrated components is not a requirement. Greater or fewer components may alternatively be implemented.

The wireless communication unit 110 may typically include one or more modules which permit wireless communications between the mobile terminal 100 and a wireless communication system or between the mobile terminal 100 and a network within which the mobile terminal 100 is located. For example, the wireless communication unit 110 may include at least one of a broadcast receiving module 111, a mobile communication module 112, a wireless Internet module 113, a short-range communication module 114, a location information module 115 and the like.

The broadcast receiving module 111 receives a broadcast signal and/or broadcast associated information from an external broadcast managing entity via a broadcast channel. The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module 111 may be configured to be suitable for every broadcast system transmitting broadcast signals as well as the digital broadcasting systems.

Broadcast signals and/or broadcast associated information received via the broadcast receiving module 111 may be stored in a suitable device, such as a memory 160.

The mobile communication module 112 transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module 112 may implement a video call mode and a voice call mode. The video call mode indicates a state of calling with watching a callee's image. The voice call mode indicates a state of calling without watching the callee's image. The wireless communication module 112 may transmit and receive at least one of voice and image in order to implement the video call mode and the voice call mode.

The wireless Internet module 113 supports wireless Internet access for the mobile terminal. This module may be internally or externally coupled to the mobile terminal 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 114 denotes a module for short-range communications. Suitable technologies for implementing this module may include BLUETOOTH™, Radio Frequency IDentification (RFID), Infrared Data Association (IrDA), Ultra-WideBand (UWB), ZigBee™, Near Field Communication (NFC) and the like.

The location information module 115 denotes a module for detecting or calculating a position of a mobile terminal. An example of the location information module 115 may include a Global Position System (GPS) module or a wireless fidelity (WiFi) module.

Still referring to FIG. 1, the A/V input unit 120 is configured to provide audio or video signal input to the mobile terminal. The A/V input unit 120 may include a camera 121 and a microphone 122. The camera 121 receives and processes image frames of still pictures or video obtained by image sensors in a video call mode or a capturing mode. The processed image frames may be displayed on a display unit 151.

The image frames processed by the camera 121 may be stored in the memory 160 or transmitted to the exterior via the wireless communication unit 110. Also, user's position information and the like may be calculated from the image frames acquired by the camera 121. Two or more cameras 121 may be provided according to the configuration of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 for the phone call mode. The microphone 122 may include assorted noise removing algorithms to remove noise generated in the course of receiving the external audio signal.

The user input unit 130 may generate input data input by a user to control the operation of the mobile terminal. The user input unit 130 may include a keypad, a dome switch, a touchpad (e.g., static pressure/capacitance), a jog wheel, a jog switch and the like.

The sensing unit 140 provides status measurements of various aspects of the mobile terminal. For instance, the sensing unit 140 may detect an open/close status of the mobile terminal, a change in a location of the mobile terminal 100, a presence or absence of user contact with the mobile terminal 100, the location of the mobile terminal 100, acceleration/deceleration of the mobile terminal 100, and the like, so as to generate a sensing signal for controlling the operation of the mobile terminal 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply 190, the presence or absence of a coupling or other connection between the interface unit 170 and an external device.

The output unit 150 is configured to output an audio signal, a video signal or a tactile signal. The output unit 150 may include a display unit 151, an audio output module 153, an alarm unit 154 and a haptic module 155.

The display unit 151 may output information processed in the mobile terminal 100. For example, when the mobile terminal is operating in a phone call mode, the display unit 151 will provide a User Interface (UI) or a Graphic User Interface (GUI), which includes information associated with the call. As another example, if the mobile terminal is in a video call mode or a capturing mode, the display unit 151 may additionally or alternatively display images captured and/or received, UI, or GUI.

The display unit 151 may be implemented using, for example, at least one of a Liquid Crystal Display (LCD), a Thin Film Transistor-Liquid Crystal Display (TFT-LCD), an Organic Light-Emitting Diode (OLED), a flexible display, a three-dimensional (3D) display, an e-ink display or the like.

Some of such displays 151 may be implemented as a transparent type or an optical transparent type through which the exterior is visible, which is referred to as ‘transparent display’. A representative example of the transparent display may include a Transparent OLED (TOLED), and the like. The rear surface of the display unit 151 may also be implemented to be optically transparent. Under this configuration, a user can view an object positioned at a rear side of a terminal body through a region occupied by the display unit 151 of the terminal body.

The display unit 151 may be implemented in two or more in number according to a configured aspect of the mobile terminal 100. For instance, a plurality of the displays 151 may be arranged on one surface to be spaced apart from or integrated with each other, or may be arranged on different surfaces.

The display unit 151 may also be implemented as a stereoscopic display unit 152 for displaying stereoscopic images. Here, the stereoscopic image may be a three-dimensional (3D) stereoscopic image, and the 3D stereoscopic image is an image refers to an image making a viewer feel that a gradual depth and reality of an object on a monitor or a screen is the same as a reality space. A 3D stereoscopic image is implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, include Wheatstone stereoscopic scheme, or the like.

The auto-stereoscopic scheme includes, for example, a parallax barrier scheme, a lenticular scheme, an integral imaging scheme, a switchable scheme, or the like. The projection scheme includes a reflective holographic scheme, a transmissive holographic scheme, or the like.

In general, a 3D stereoscopic image is comprised of a left image (a left eye image) and a right image (a right eye image). According to how left and right images are combined into a 3D stereoscopic image, the 3D stereoscopic imaging method is divided into a top-down method in which left and right images are disposed up and down in a frame, an L-to-R (left-to-right, side by side) method in which left and right images are disposed left and right in a frame, a checker board method in which fragments of left and right images are disposed in a tile form, an interlaced method in which left and right images are alternately disposed by columns and rows, and a time sequential (or frame by frame) method in which left and right images are alternately displayed by time.

Also, as for a 3D thumbnail image, a left image thumbnail and a right image thumbnail are generated from a left image and a right image of the original image frame, respectively, and then combined to generate a single 3D thumbnail image. In general, thumbnail refers to a reduced image or a reduced still image. The thusly generated left image thumbnail and the right image thumbnail are displayed with a horizontal distance difference therebetween by a depth corresponding to the disparity between the left image and the right image on the screen, providing a stereoscopic space sense.

As illustrated, a left image and a right image required for implementing a 3D stereoscopic image is displayed on the stereoscopic display unit 152 by a stereoscopic processing unit. The stereoscopic processing unit may receive the 3D image and extract the left image and the right image, or may receive the 2D image and change it into a left image and a right image.

Here, if the display unit 151 and a touch sensitive sensor (referred to as a touch sensor) have a layered structure therebetween (referred to as a ‘touch screen’), the display unit 151 may be used as an input device as well as an output device. The touch sensor may be implemented as a touch film, a touch sheet, a touchpad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also touch pressure. Here, a touch object is an object to apply a touch input onto the touch sensor. Examples of the touch object may include a finger, a touch pen, a stylus pen, a pointer or the like.

When touch inputs are sensed by the touch sensors, corresponding signals are transmitted to a touch controller. The touch controller processes the received signals, and then transmits corresponding data to the controller 180. Accordingly, the controller 180 may sense which region of the display unit 151 has been touched.

Still referring to FIG. 1, a proximity sensor 141 may be arranged at an inner region of the mobile terminal 100 covered by the touch screen, or near the touch screen. The proximity sensor 141 may be provided as one example of the sensing unit 140. The proximity sensor 141 indicates a sensor to sense presence or absence of an object approaching to a surface to be sensed, or an object disposed near a surface to be sensed, by using an electromagnetic field or infrared rays without a mechanical contact. The proximity sensor 141 has a longer lifespan and a more enhanced utility than a contact sensor.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of brief explanation, a status that the pointer is positioned to be proximate onto the touch screen without contact will be referred to as ‘proximity touch’, whereas a status that the pointer substantially comes in contact with the touch screen will be referred to as ‘contact touch’. For the position corresponding to the proximity touch of the pointer on the touch screen, such position corresponds to a position where the pointer faces perpendicular to the touch screen upon the proximity touch of the pointer.

The proximity sensor 141 senses proximity touch, and proximity touch patterns (e.g., distance, direction, speed, time, position, moving status, etc.). Information relating to the sensed proximity touch and the sensed proximity touch patterns may be output onto the touch screen.

When a touch sensor is overlaid on the stereoscopic display unit 152 in a layered manner (hereinafter, referred to as ‘stereoscopic touch screen’), or when the stereoscopic display unit 152 and a 3D sensor sensing a touch operation are combined, the stereoscopic display unit 152 may also be used as a 3D input device.

As examples of the 3D sensor, the sensing unit 140 may include a proximity sensor 141, a stereoscopic touch sensing unit 142, an ultrasonic sensing unit 143, and a camera sensing unit 144. The proximity sensor 141 detects the distance between a sensing object (e.g., the user's finger or a stylus pen) applying a touch by using the force of electromagnetism or infrared rays without a mechanical contact and a detect surface. By using the distance, the terminal recognizes which portion of a stereoscopic image has been touched. In particular, when the touch screen is an electrostatic touch screen, the degree of proximity of the sensing object is detected based on a change of an electric field according to proximity of the sensing object, and a touch to the 3D image is recognized by using the degree of proximity.

The stereoscopic touch sensing unit 142 is configured to detect the strength or duration of a touch applied to the touch screen. For example, the stereoscopic touch sensing unit 142 may sense touch pressure. When the pressure is strong, it may recognize the touch as a touch with respect to an object located farther away from the touch screen toward the inside of the terminal.

The ultrasonic sensing unit 143 is configured to recognize position information of the sensing object by using ultrasonic waves. The ultrasonic sensing unit 143 may include, for example, an optical sensor and a plurality of ultrasonic sensors. The optical sensor is configured to sense light and the ultrasonic sensors may be configured to sense ultrasonic waves. Since light is much faster than ultrasonic waves, a time for which the light reaches the optical sensor is much shorter than a time for which the ultrasonic wave reaches the ultrasonic sensor. Therefore, a position of a wave generation source may be calculated by using a time difference from the time that the ultrasonic wave reaches based on the light as a reference signal.

The camera sensing unit 144 includes at least one of a camera 121, a photo sensor, and a laser sensor. For example, the camera 121 and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the display device. The photo sensor is configured to scan a movement of the sensing object in proximity to the touch screen. In detail, the photo sensor includes photo diodes and transistors at rows and columns to scan content mounted on the photo sensor by using an electrical signal changing according to the quantity of applied light. Namely, the photo sensor calculates the coordinates of the sensing object according to variation of light to thus obtain position information of the sensing object.

The audio output module 153 may convert and output as sound audio data received from the wireless communication unit 110 or stored in the memory 160 in a call signal reception mode, a call mode, a record mode, a voice recognition mode, a broadcast reception mode, and the like. Also, the audio output module 153 may provide audible outputs related to a particular function performed by the mobile terminal 100 (e.g., a call signal reception sound, a message reception sound, etc.). The audio output module 153 may include a speaker, a buzzer or the like.

The alarm unit 154 outputs a signal for informing about an occurrence of an event of the mobile terminal 100. Events generated in the mobile terminal may include call signal reception, message reception, key signal inputs, a touch input etc. In addition to video or audio signals, the alarm unit 154 may output signals in a different manner, for example, using vibration to inform about an occurrence of an event. The video or audio signals may be also output via the audio output module 153, so the display unit 151 and the audio output module 153 may be classified as parts of the alarm unit 154.

A haptic module 155 generates various tactile effects the user may feel. A typical example of the tactile effects generated by the haptic module 155 is vibration. The strength and pattern of the haptic module 155 can be controlled. For example, different vibrations may be combined to be output or sequentially output.

Besides vibration, the haptic module 155 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 155 may be implemented to allow the user to feel a tactile effect through a muscle sensation such as fingers or arm of the user, as well as transferring the tactile effect through a direct contact. Two or more haptic modules 155 may be provided according to the configuration of the mobile terminal 100.

The memory 160 may store software programs used for the processing and controlling operations performed by the controller 180, or may temporarily store data (e.g., a phonebook, messages, still images, video, etc.) that are input or output. In addition, the memory 160 may store data regarding various patterns of vibrations and audio signals output when a touch is input to the touch screen.

The memory 160 may include at least one type of storage medium including a Flash memory, a hard disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via the interface unit 170.

When the mobile terminal 100 is connected with an external cradle, the interface unit 170 may serve as a passage to allow power from the cradle to be supplied therethrough to the mobile terminal 100 or may serve as a passage to allow various command signals input by the user from the cradle to be transferred to the mobile terminal therethrough. Various command signals or power input from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

Also, the controller 180 may execute a lock state to restrict a user from inputting control commands for applications when a state of the mobile terminal meets a preset condition. Also, the controller 180 may control a lock screen displayed in the lock state based on a touch input sensed on the display unit 151 in the lock state of the mobile terminal.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof. For a hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some instances, such embodiments may be implemented by the controller 180 itself.

For a software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

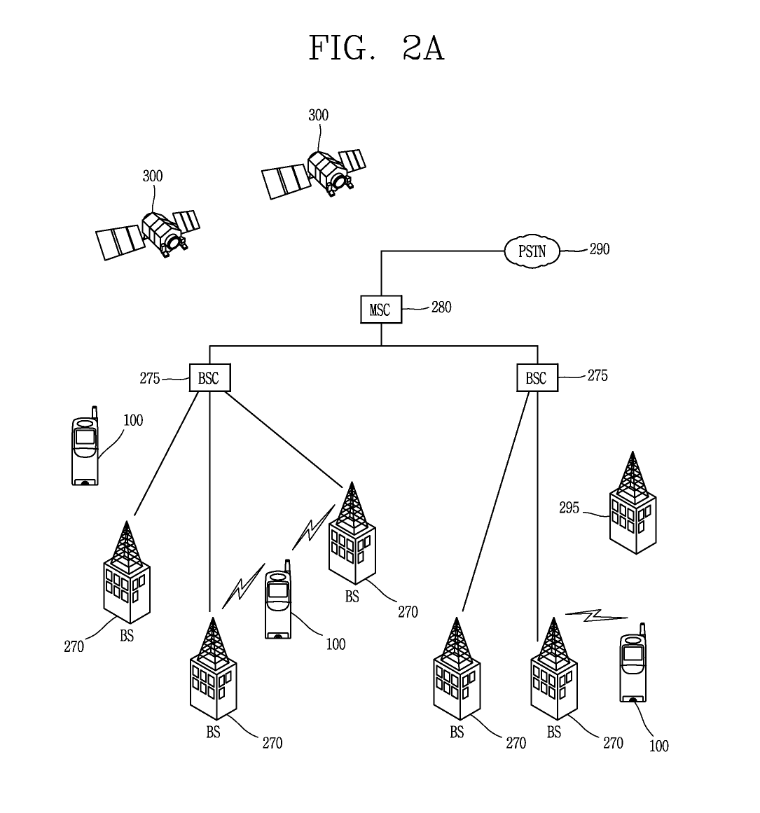

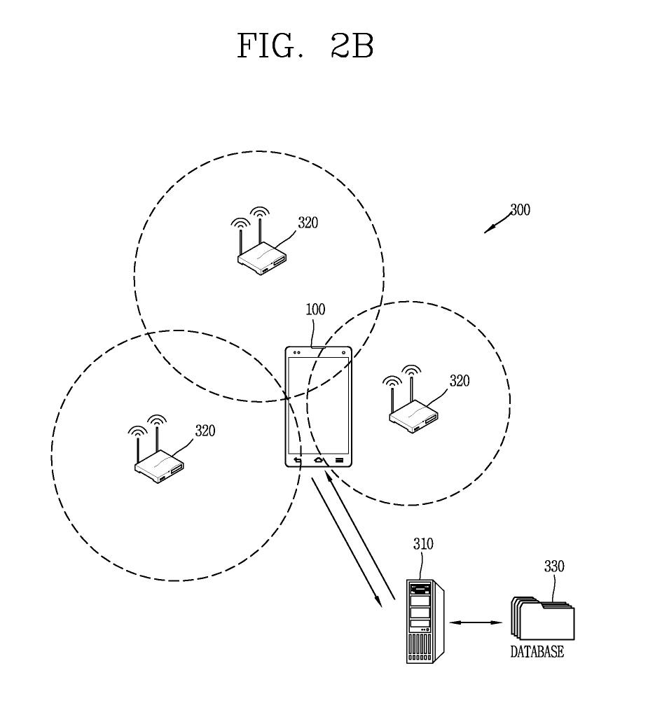

Hereinafter, a communication system which is operable with the mobile terminal 100 according to the present invention will be described. In particular, FIGS. 2A and 2B are conceptual views of a communication system operable with a mobile terminal 100 in accordance with the present invention.

First, referring to FIG. 2A, such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like.

By way of non-limiting example only, further description will relate to a CDMA communication system, but such teachings apply equally to other system types including the CDMA wireless communication system.

Referring now to FIG. 2A, a CDMA wireless communication system is shown having a plurality of mobile terminals 100, a plurality of base stations (BSs) 270, base station controllers (BSCs) 275, and a mobile switching center (MSC) 280. The MSC 280 is configured to interface with a conventional Public Switch Telephone Network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs 275 can be included in the system as shown in FIG. 2a.

Each base station 270 may include one or more sectors, each sector having an omni-directional antenna or an antenna pointed in a particular direction radially away from the base station 270. Alternatively, each sector may include two or more different antennas. Each base station 270 may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations 270 may also be referred to as Base Station Transceiver Subsystems (BTSs). In some cases, the term “base station” may be used to refer collectively to a BSC 275, and one or more base stations 270. The base stations may also be denoted as “cell sites.” Alternatively, individual sectors of a given base station 270 may be referred to as cell sites.

A broadcasting transmitter (BT) 295, as shown in FIG. 2A, transmits a broadcast signal to the mobile terminals 100 operating within the system. The broadcast receiving module 111 is typically configured inside the mobile terminal 100 to receive broadcast signals transmitted by the BT 295.

FIG. 2A further depicts several Global Positioning System (GPS) satellites 300. Such satellites 300 facilitate locating the position of at least one of plural mobile terminals 100. Two satellites are depicted in FIG. 2A, but useful position information may be obtained with greater or fewer satellites than two satellites. The GPS module 115 (FIG. 1) is typically configured to cooperate with the satellites 300 to obtain desired position information. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

During typical operation of the wireless communication system, the base stations 270 receive sets of reverse-link signals from various mobile terminals 100. The mobile terminals 100 are engaging in calls, messaging, and executing other communications. Each reverse-link signal received by a given base station 270 is processed within that base station 270. The resulting data is forwarded to an associated BSC 275.

The BSC 275 provides call resource allocation and mobility management functionality including the orchestration of soft handoffs between base stations 270. The BSCs 275 also route the received data to the MSC 280, which then provides additional routing services for interfacing with the PSTN 290. Similarly, the PSTN 290 interfaces with the MSC 280, and the MSC 280 interfaces with the BSCs 275, which in turn control the base stations 270 to transmit sets of forward-link signals to the mobile terminals 100.

Hereinafter, description will be given of a method for acquiring location information of a mobile terminal using a wireless fidelity (WiFi) positioning system (WPS), with reference to FIG. 2B.

The WiFi positioning system (WPS) 300 refers to a location determination technology based on a wireless local area network (WLAN) using WiFi as a technology for tracking the location of the mobile terminal 100 using a WiFi module provided in the mobile terminal 100 and a wireless access point 320 for transmitting and receiving to and from the WiFi module.

The WiFi positioning system 300 may include a WiFi location determination server 310, a mobile terminal 100, a wireless access point (AP) 320 connected to the mobile terminal 100, and a database 330 stored with any wireless AP information.

The WiFi location determination server 310 extracts the information of the wireless AP 320 connected to the mobile terminal 100 based on a location information request message (or signal) of the mobile terminal 100. The information of the wireless AP 320 may be transmitted to the WiFi location determination server 310 through the mobile terminal 100 or transmitted to the WiFi location determination server 310 from the wireless AP 320.

The information of the wireless AP extracted based on the location information request message of the mobile terminal 100 may be at least one of MAC address, SSID, RSSI, channel information, privacy, network type, signal strength and noise strength.

The WiFi location determination server 310 receives the information of the wireless AP 320 connected to the mobile terminal 100 as described above, and compares the received wireless AP 320 information with information contained in the pre-established database 330 to extract (or analyze) the location information of the mobile terminal 100.

In addition, referring to FIG. 2B, as an example, the wireless AP connected to the mobile terminal 100 is illustrated as a first, a second, and a third wireless AP 320. However, the number of wireless APs connected to the mobile terminal 100 may be changed in various ways according to a wireless communication environment in which the mobile terminal 100 is located. When the mobile terminal 100 is connected to at least one of wireless APs, the WiFi positioning system 300 can track the location of the mobile terminal 100.

Next, considering the database 330 stored with any wireless AP information in more detail, various information of any wireless APs disposed at different locations may be stored in the database 330.

The information of any wireless APs stored in the database 330 may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like.

In this manner, any wireless AP information and location information corresponding to the any wireless AP are stored together in the database 330, and thus the WiFi location determination server 310 may retrieve wireless AP information corresponding to the information of the wireless AP 320 connected to the mobile terminal 100 from the database 330 to extract the location information matched to the searched wireless AP, thereby extracting the location information of the mobile terminal 100.

Furthermore, the extracted location information of the mobile terminal 100 may be transmitted to the mobile terminal 100 through the WiFi location determination server 310, thereby acquiring the location information of the mobile terminal 100.

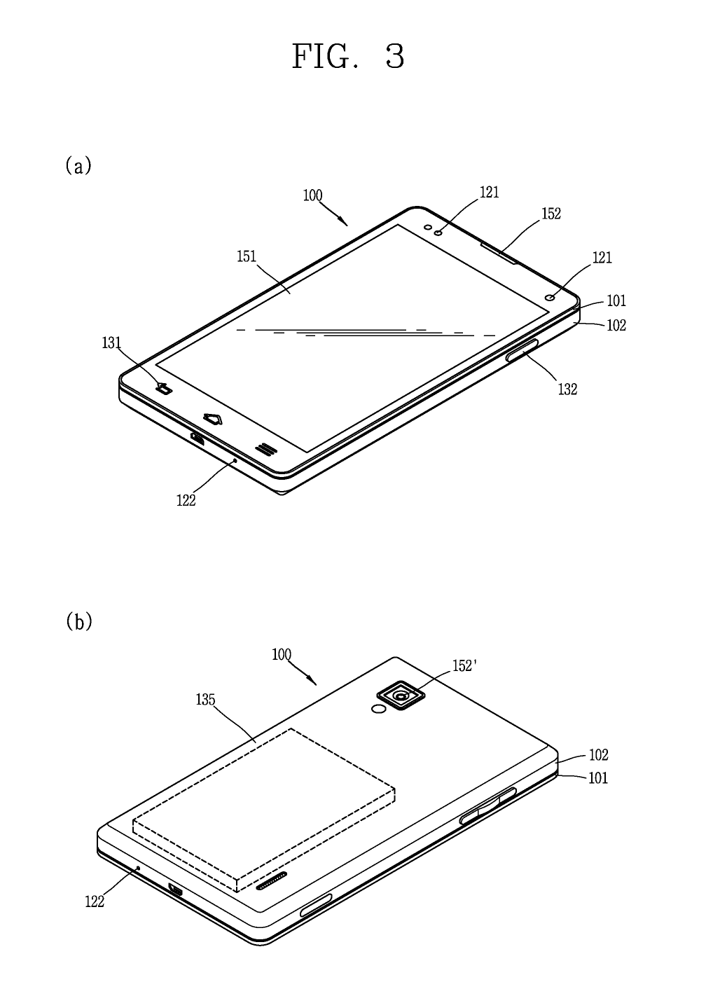

FIG. 3(a) is a front perspective view illustrating an example of the mobile terminal 100 associated with the present invention. The mobile terminal 100 disclosed herein is provided with a bar-type terminal body. However, the present invention is not limited to this, but also may be applicable to various structures such as watch type, clip type, glasses type or folder type, flip type, swing type, swivel type, or the like, in which two and more bodies are combined with each other in a relatively movable manner.

The body includes a case (casing, housing, cover, etc.) forming the appearance of the terminal. In this embodiment, the case may be divided into a front case 101 and a rear case 102. Various electronic components are incorporated into a space formed between the front case 101 and the rear case 102. At least one middle case may be additionally disposed between the front case 101 and the rear case 102, and a battery cover 103 for covering the battery 191 may be detachably configured at the rear case 102. The cases may be formed by injection-molding a synthetic resin or may be also formed of a metal, for example, stainless steel (STS), titanium (Ti), or the like.

A display unit 151, a first audio output module 153a, a first camera 121a, a first manipulating unit 131 and the like may be disposed on a front surface of the terminal body, and a microphone 122, an interface unit 170, a second manipulating unit 132 and the like may be provided on a lateral surface thereof.

The display unit 151 may be configured to display (output) information being processed in the mobile terminal 100. The display unit 151 may include at least one of a liquid crystal display (LCD), a thin film transistor-liquid crystal display (TFT-LCD), an organic light emitting diode (OLED) display, a flexible display, a 3-dimensional (3D) display, and an e-ink display.

The display unit 151 may include a touch sensing mechanism to receive a control command by a touch method. When a touch is made to any one place on the display unit 151, the touch sensing mechanism may be configured to sense this touch and enter the content corresponding to the touched place. The content entered by a touch method may be a text or numerical value, or a menu item capable of indication or designation in various modes.

The touch sensing mechanism may be formed with transparency to allow visual information displayed on the display unit 151 to be seen, and may include a structure for enhancing the visibility of a touch screen at bright places. Referring to FIG. 3a, the display unit 151 occupies a most portion of the front surface of the front case 101.

The first audio output unit 153a and the first camera 121a are disposed in a region adjacent to one of both ends of the display unit 151, and the first manipulation input unit 131 and the microphone 122 are disposed in a region adjacent to the other end thereof. The second manipulation interface 132 (refer to FIG. 3(b)), the interface 170, and the like may be disposed on a lateral surface of the terminal body.

The first audio output module 153a may be implemented in the form of a receiver for transferring voice sounds to the user's ear or a loud speaker for outputting various alarm sounds or multimedia reproduction sounds.

It may be configured such that the sounds generated from the first audio output module 153a are released along an assembly gap between the structural bodies. In this case, a hole independently formed to output audio sounds may not be seen or hidden in terms of appearance, thereby further simplifying the appearance of the mobile terminal 100. However, the present invention is not limited to this, but a hole for releasing the sounds may be formed on the window.

The first camera 121a processes video frames such as still or moving images obtained by the image sensor in a video call mode or capture mode. The processed video frames may be displayed on the display unit 151.

The user input unit 130 is manipulated to receive a command for controlling the operation of the mobile terminal 100. The user input unit 130 may include a first and a second manipulation unit 131, 132. The first and the second manipulation unit 131, 132 may be commonly referred to as a manipulating portion, and any method may be employed if it is a tactile manner allowing the user to perform manipulation with a tactile feeling such as touch, push, scroll or the like.

The present drawing illustrates the first manipulation unit 131 is a touch key, but the present invention may not be necessarily limited to this. For example, the first manipulation unit 131 may be configured with a mechanical key, or a combination of a touch key and a mechanical key.

The content received by the first and/or second manipulation units 131, 132 may be set in various ways. For example, the first manipulation unit 131 may be used to receive a command such as menu, home key, cancel, search, or the like, and the second manipulation unit 132 may receive a command, such as controlling a volume level being output from the first audio output module 153a, or switching into a touch recognition mode of the display unit 151.

The microphone 122 may be formed to receive the user's voice, other sounds, or the like. The microphone 122 may be provided at a plurality of places, and configured to receive stereo sounds.

The interface unit 170 serves as a path allowing the mobile terminal 100 to exchange data with external devices. For example, the interface unit 170 may be at least one of a connection terminal for connecting to an earphone in a wired or wireless manner, a port for near field communication (for example, an Infrared Data Association (IrDA) port, a Bluetooth port, a wireless LAN port, and the like), and a power supply terminal for supplying power to the mobile terminal 100. The interface unit 170 may be implemented in the form of a socket for accommodating an external card such as Subscriber Identification Module (SIM) or User Identity Module (UIM), and a memory card for information storage.

FIG. 3(b) is a rear perspective view illustrating mobile terminal 100 illustrated in FIG. 3(a). Referring to FIG. 3(b), a second camera 121b may be additionally mounted at a rear surface of the terminal body, namely, the rear case 102. The second camera 121b has an image capturing direction, which is substantially opposite to the direction of the first camera unit 121a (refer to FIG. 3a), and may have a different number of pixels from that of the first camera unit 121a.

For example, it is preferable that the first camera 121a has a relatively small number of pixels enough not to cause difficulty when the user captures his or her own face and sends it to the other party during a video call or the like, and the second camera 121b has a relatively large number of pixels since the user often captures a general object that is not sent immediately. The first and the second camera 121a, 121b may be provided in the terminal body in a rotatable and popupable manner.

Furthermore, a flash 123 and a mirror 124 may be additionally disposed adjacent to the second camera 121b. The flash 123 illuminates light toward an object when capturing the object with the second camera 121b. The mirror 124 allows the user to look at his or her own face, or the like, in a reflected way when capturing himself or herself (in a self-portrait mode) by using the second camera 121b.

A second audio output unit 153b may be additionally disposed at a rear surface of the terminal body. The second audio output unit 153b together with the first audio output unit 153a (refer to FIG. 3(a)) can implement a stereo function, and may be also used to implement a speaker phone mode during a phone call.

An antenna for receiving broadcast signals may be additionally disposed at a lateral surface of the terminal body in addition to an antenna for making a phone call or the like. The antenna constituting part of the broadcast receiving module 111 may be provided in the terminal body in a retractable manner.

A power supply unit 190 for supplying power to the mobile terminal 100 may be mounted on the terminal body. The power supply unit 190 may be incorporated into the terminal body, or may include a battery 191 configured in a detachable manner on the outside of the terminal body. According to the drawing, it is illustrated that the battery cover 103 is combined with the rear case 102 to cover the battery 191, thereby restricting the battery 191 from being released and protecting the battery 191 from external shocks and foreign substances.

With the help of these improvements, there is an increasing need for an agent that manages all or some functions of the mobile terminal. However, the existing agent manages the mobile terminal indiscriminately without considering a user's usage pattern and the like. In addition, there is a problem in that the existing agent manages only some limited functions.

Accordingly, a mobile terminal 100 including the agent that improves user convenience and a method of controlling the mobile terminal 100 are described below referring to the accompanying drawings.

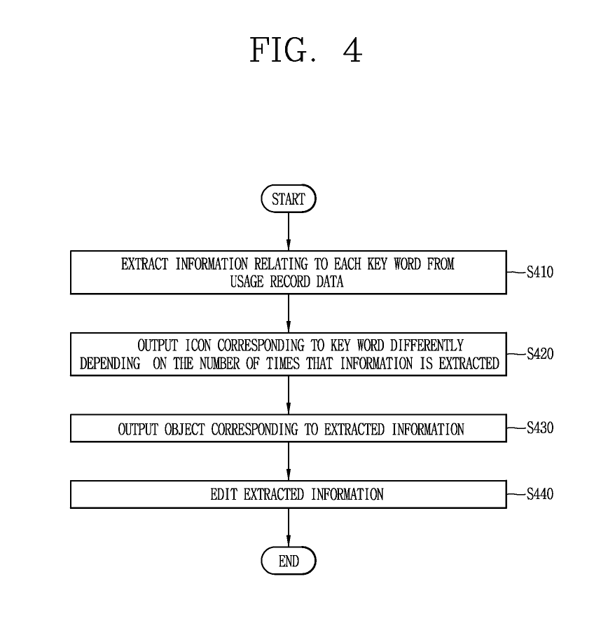

FIG. 4 is a flowchart illustrating the mobile terminal 100 according to one embodiment of the present invention 100. The mobile terminal 100 includes the controller 180 and the display unit 151.

Referring to FIG. 4, the controller 180 extracts information including a user's usage pattern associated with pre-set multiple keywords keyword by keyword from usage record data on the mobile terminal 100 (S410). Specifically, the usage record data is defined as a series of tasks in which the user uses the mobile terminal 100. For example, a series of tasks in which the user searches for “Jejudo Dol Haru Bang” over the Internet is an example of the usage record data.

In addition, the multiple keywords are input from the user or are initially set. Such keywords are defined as a reference for collecting related information. For example, the user can input key words “Jejudo tour.” Accordingly, information on Dol Haru Bang is extracted as information relating to “Jejudo tour” (information relating to key words) over the Internet.

The information relating to the key word includes the user's usage pattern. The user's usage pattern is defined as a series of tasks in which the user repeatedly uses the mobile terminal 100. Specifically, if the user repeatedly inputs a specific control command or executes a specific function, this is included in the user's usage pattern.

Next, an icon corresponding to each key word is differently output depending on the number of times that information relating to each key word is extracted (S420). For example, the icon corresponding to the key words “Jejudo tour” is output differently step by step depending on the number of times that the information relating to “Jejudo tour” is extracted. In addition, an icon corresponding to “USA tour” is output in a different shape than the icon corresponding to the JEJUDO tour.”

Subsequently, an object corresponding to the extracted information is output to the display unit 151 (S430). If information on the Jejudo hotel is extracted as the information relating to “Jejudo tour,” a message window (an object corresponding to the extracted information) is output that asks whether or not to have access to a hotel reservation site.

Next, the information relating to each key word is edited by selecting and deleting one among extracted items of information or by adding information to be newly input (S440). For example, the user can select and delete the information on Dol Haru Bang among the extracted items of information relating to “Jejudo tour” and can input and add information on hotels in Jejudo. Accordingly, the information relating to “Jejudo tour” is edited.

Referring to FIG. 1, the controller 180 includes multiple agents 182. Depending on its type, each agent manages all function of the mobile terminal 100 integrally, or manages only a pre-set function limitedly. The user can have such an agent downloaded and installed. Alternatively, the mobile terminal 100 comes with such an agent pre-installed.

As an embodiment, the existing agent may be downloaded and installed using an account through which the existing agent is installed in association with the number of the mobile terminal 100. In addition, a new agent can be installed or only one function included in the agent can be downloaded.

As another embodiment, the agent is pre-installed, and a button corresponding to the agent is output to a notification area. The user can execute the agent by touching on the button. If the information relating to the key word is collected, a message that recommends execution of the agent is output.

As another embodiment, the agent may be present, in the form of an application, on a menu. Further, by inputting, the user can generate an initial setting value (for example, a key word, or personal information) on the application.

The agent installed in this manner extracts the information including the user's usage pattern associated with the pre-set key word from the usage record data on the mobile terminal 100. In addition, the multiple agents can be present in the controller 180.

As an embodiment, a “Jejudo tour agent” may extract information relating to the key words, “Jejudo tour,” and a “USA tour agent” may extract information relating to the key words “USA tour.” That is, the key word assigned to each agent is defined as a reference against which the agent extracts the information. As described above, the agent extracts a constant usage pattern from a record of user's normal usage of the mobile terminal 100. Then, the agent determines whether the extracted usage pattern is suitable for the user, and provides the user with the result of determination.

Subsequently, when the extracted usage pattern receives feedback suitable for the user, an interface is output in which such an extracted usage pattern is more easily executed or a related function is automatically proposed. Then, each time the usage pattern that is extracted and receives suitable feedback increases in number, the icon corresponding to the agent changes. For example, if an icon of the agent takes on the shape of a child, each time the usage pattern receives the suitable feedback increased in number, the icon in the shape of a child increases in height.

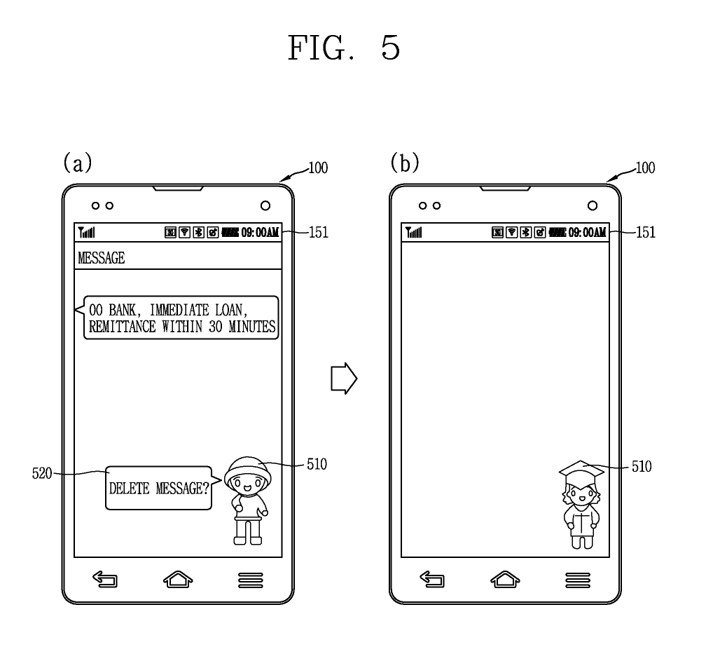

Next, FIGS. 5(a) and 5(b) are diagrams illustrating an embodiment of a user interface associated with a message reception agent. The message reception agent is pre-set. The message reception agent is set such that the information relating to “message reception” is extracted by inputting key words “message reception.”

Accordingly, from a series of tasks (the usage record data) in which the user transmits and receives, the message reception agent extracts a usage pattern (agent information) indicating the user deletes the message when the received message includes the word “loan.”

Referring to FIG. 5(a), when the message including the word “loan” is received, an icon 510 corresponding to the message reception agent is automatically output. In addition, the user can request (call) the icon 510 by inputting a double tap and the like.

In addition, an object 520 corresponding to the previously extracted usage pattern can be output. Specifically, a message window 520 that asks whether or not to delete a message can be output.

Referring to FIG. 5(b), if the user selects message deletion, the icon 510 corresponding to the message reception agent is changed differently than in FIG. 5(a). That is, the icon 510 that is expressed as a kindergartner in FIG. 5(a) is changed as illustrated as a graduate wearing a cap and gown.

This corresponding to an increase in the number of the message reception agents that are extracted by the user's usage pattern. Specifically, the agent proposes a specific action (proposes message deletion), based on the user's usage pattern (learned pattern) that is extracted. If the extracted usage pattern is suitable, the user can input feedback corresponding to this suitability.

Accordingly, the icon corresponding to the agent is output so that icon grows in the shape of a human being. In addition, as described above, the usage pattern that receives the suitable feedback is executed without a user's input. For example, if the feedback is received as illustrated in FIG. 5, when the message including the word “loan” is received, that message is automatically deleted without asking the user whether or not to perform the message deletion.

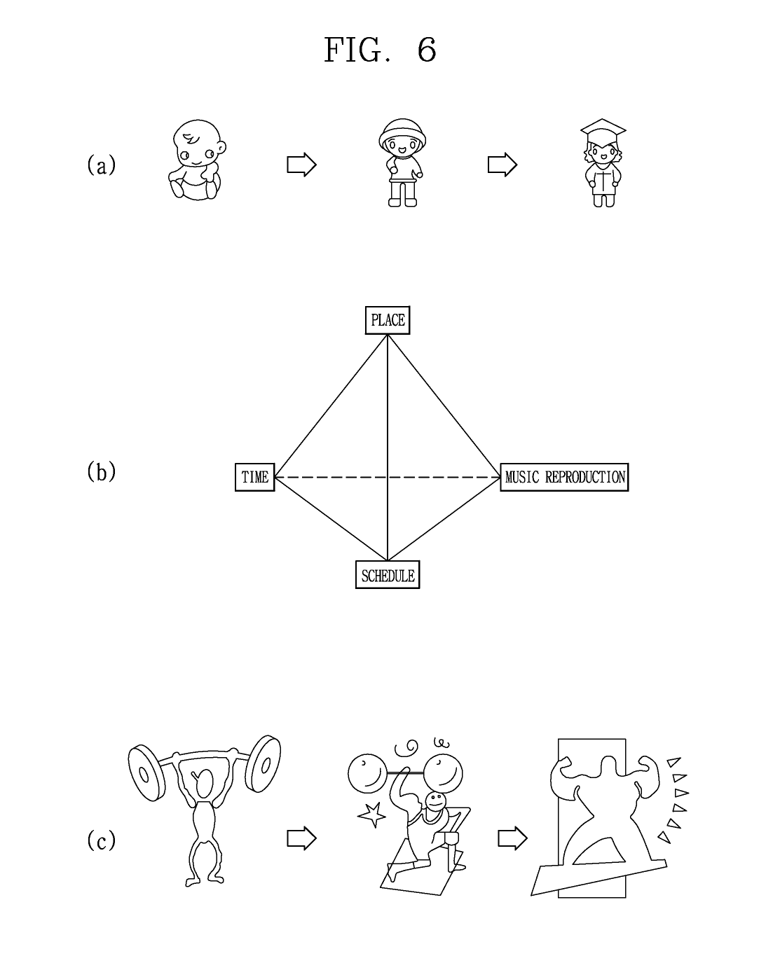

Next, FIGS. 6(a) to 6(c) are diagrams illustrating an embodiment of the user interface associated with the icon corresponding to the agent. Referring to FIG. 6(a), the icon corresponding to the agent is changed in the shape of a human being that grows depending on the number of times that learning takes place. For example, the icon in the shape of a child at the beginning grows into the shape of a kindergarten and then a graduate, depending on the extent of learning.

That is, as described above, as the suitable usage pattern received by the agent increases in number, the icon in the shape of a child grows into the shape of a kindergarten and then a graduate. In addition, an operation period of a sensor of the agent with which the usage pattern is extracted is differently set depending on the number of times that the suitable usage pattern is extracted.

Specifically, the sensor of the agent that does not almost extract the suitable usage pattern is made to operate with a comparatively short period and thus to newly the multiple usage patterns. In contrast, the sensor of the agent that extracts the multiple suitable usage pattern operates with a comparatively long period and thus newly extracts the missing usage pattern.

Referring to FIG. 6(b), the icon corresponding to the agent is expressed in the form of a polyhedron. For example, a schedule management agent checks a user's schedule and when the user is scheduled to visit a certain place, automatically reproduces music for the user, based on the visiting time.

Accordingly, an icon corresponding to the schedule management agent is expressed in the form of a polyhedron representing elements such as place, time, schedule, and music reproducing. That is, a polyhedron icon corresponding to the agent is displayed with a currently recognized element on a ground. By viewing the polyhedron, the user can grasp the recognized information and add or delete the other elements.

FIG. 6(c) illustrates that an icon corresponding to an exercise agent changes. Specifically, the exercise agent extracts the time when the user exercised in a fitness center, body sizes, an exercise record, and so forth, as items of related information.

For example, the exercise agent inputs the when the user exercised in the fitness center, after exercise, and as an amount of body muscle that is input is further increased, the icon corresponding to the exercise agent is expressed in the shape of a human being that becomes stronger.

The icon corresponding to the exercise agent is output on a background image corresponding to a current position of the mobile terminal 100. The icon of the agent that is output at this time is an icon of the agent associated with the current position or an icon of the agent that is arbitrarily called by the user.

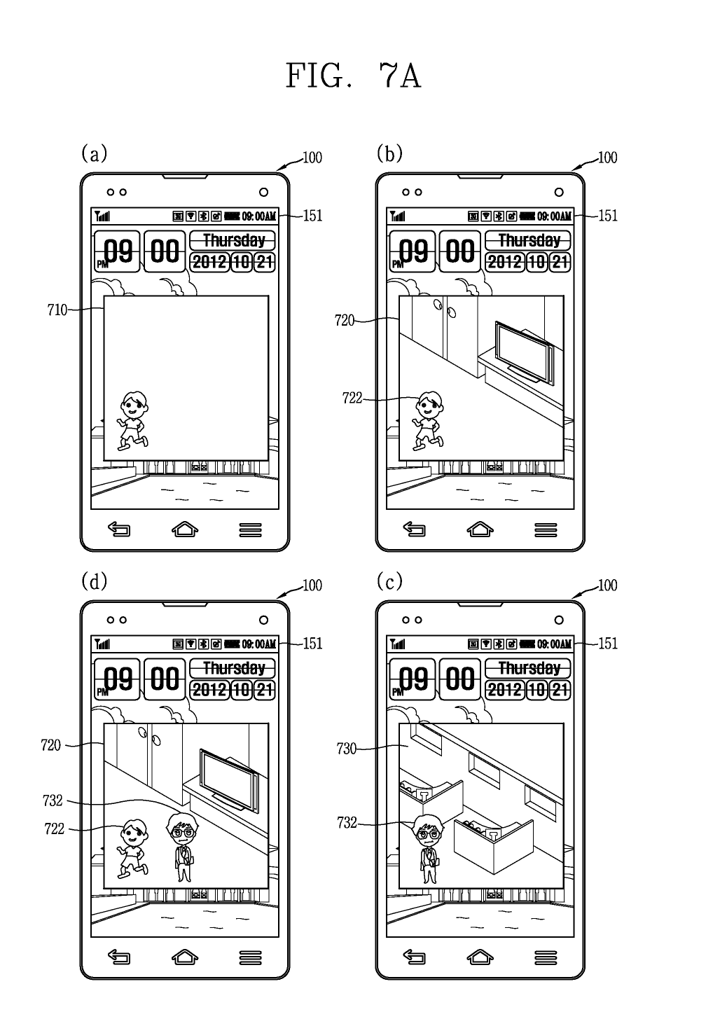

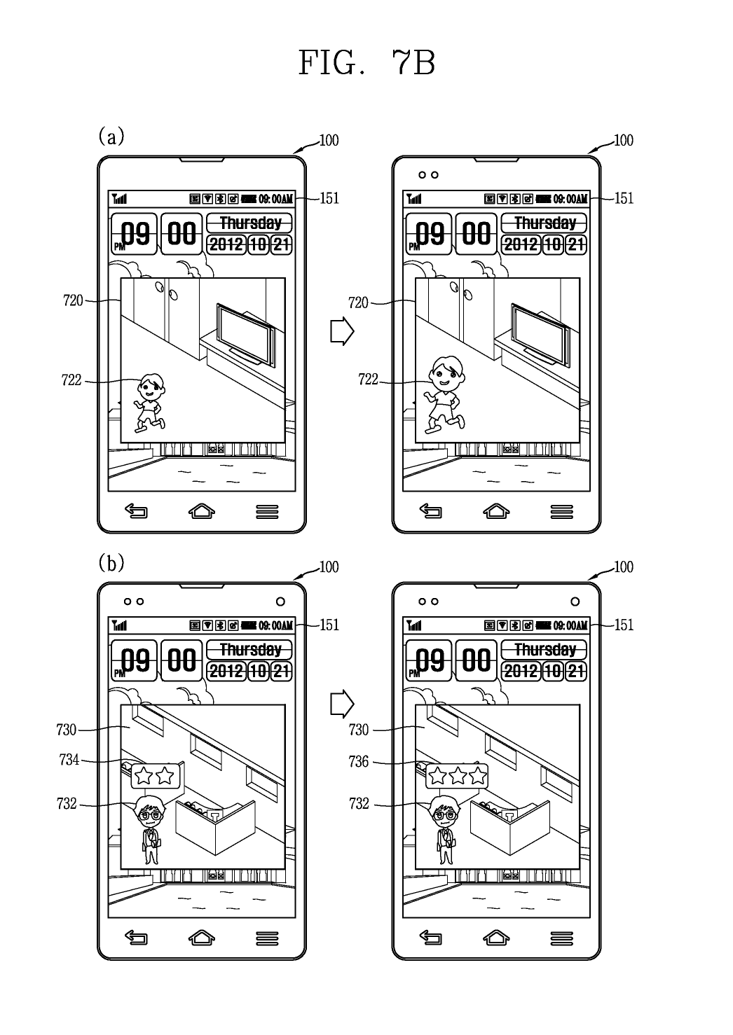

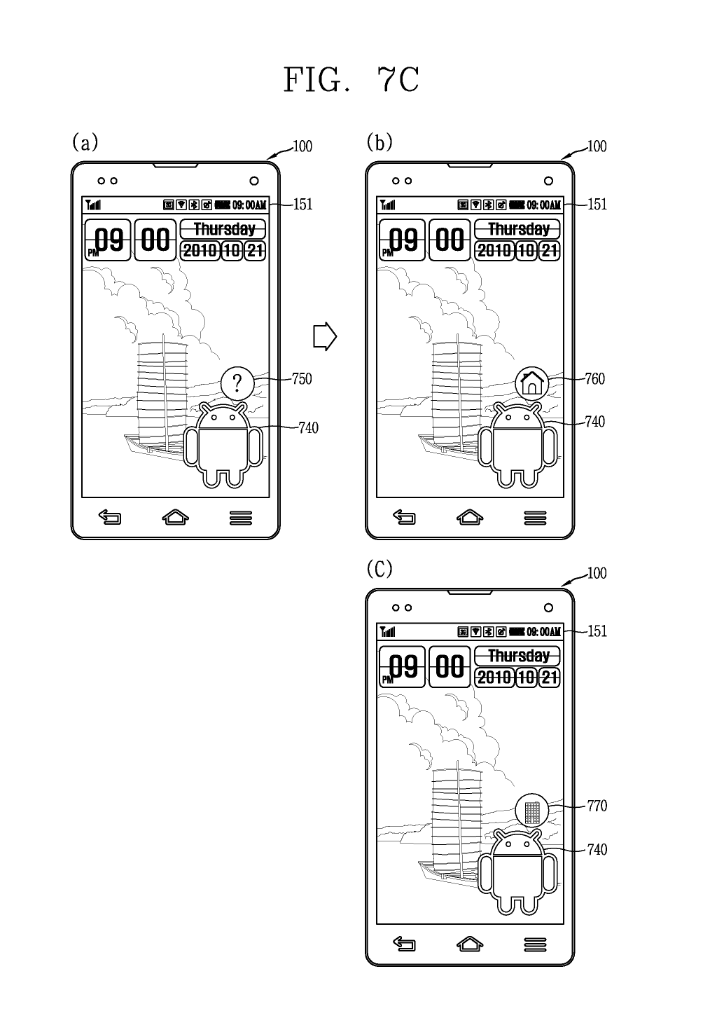

Next, FIGS. 7A(a) to 7A(d) are diagrams illustrating an embodiment of the background image to which the icon corresponding to the agent is output. Referring to FIG. 7A(a), if the current position of the mobile terminal 100 is not recognized or learned information relating to the current position is not present, the icon of the agent is output on a background image 710 indicating unoccupied space.

Referring to FIG. 7A(b), if the current position of the mobile terminal 100 is recognized as a home of the user, an icon 722 of a home agent is output on a background image 720 indicating the house. Referring to FIG. 7A(c), the current position of the mobile terminal 100 is recognized as a company that the user works for, an icon 732 of a business agent is output on a background image 730 indicating the company.

In addition, the agent that is output on different background images extracts different usage patterns and accordingly provides different functions. Further, the home agent may execute a function used for controlling the home or an application that is frequently used in the home. For example, the home agent can detect room temperature, room humidity, and so forth and propose ventilation (e.g., heater or A/C) or execute a TV application that is frequently in the home. As another embodiment, the company agent can provide a function associated with the business. For example, the company agent executes a business email or reminds the user of a meeting schedule.

Referring to FIG. 7A(d), if the user requests the icon 732 of the business agent although the current position of the mobile terminal 100 is in the home, the icon 732 of the business agent is output on the background image 720 indicating the home. As an embodiment, the icon 732 of the business agent and the icon 722 of the home agent are output together on the background image 720 indicating the home.

That is, if a place where the mobile terminal 100 is frequently positioned is recognized, and as a result corresponds to a place that has the learned information, a background image corresponding to the place and an icon corresponding to the agent are output. The agents can also be separately managed and grow depending on their respective types.

Next, FIGS. 7B(a) and 7B(b) are diagrams illustrating an embodiment in which the icon of the agent according to the background image grows. Referring to FIG. 7B(a), if the user frequently executes the TV application in the home, the home agent extracts this as the usage pattern and when a location of the user is detected as being in the room, executes the TV application.

The home agent to which the suitable usage pattern is fed back is changed in the shape that grows. For example, an increase in the suitable usage pattern is displayed so that it is intuitively recognized, by gradually increasing the size of the icon 722 of the home agent.

Referring to FIG. 7B(b), the company agent extracts the usage pattern in which the business email is started at given time in the company and automatically starts the company email at the given time. As the suitable usage pattern extracted by the company agent increases in number in this manner, the number of stars (734 and 736) that are output adjacent to the icon 732 of the company agent increases. Accordingly, the user intuitively can see that the suitable usage pattern extracted by the company agent increases in number. Further, the place that is detected by the agent may be expressed as an icon indicating the background instead of as the background image.

Next, FIGS. 7C(a) to 7C(c) are diagrams illustrating an embodiment indicating the place detected by the agent as an icon of the background. Further, each icon 740 of the agents is output in the same shape, or instead of each icon 740, a different icon is output.

Referring to FIG. 7C(a), if the currently-detected place is not the learned place, specifically if the currently-detected place is not the place from which the suitable usage pattern is extracted, an icon 750 of a question indicating this result of the detection is output as the background icon.

Referring FIG. 7C(b), if the currently-detected place is recognized as the home from which the suitable usage pattern is extracted, an icon 760 of the home indicating this is output. Referring to FIG. 7C(c), if the currently-detected place is recognized as the company from which the suitable usage pattern is extracted, an icon 770 of the company indicating this is output.

As described above, each agent proposes and execute a different function, according to the place and is output in a different shape, depending on the number of times that the suitable feedback on the extracted usage pattern takes place. Specifically, the agents that are output in the shape of the same icon 740 are in different shapes, depending on the number of the suitable usages pattern that is extracted according to the place.

For example, the home agent that detects the current place as the home extracts more suitable usage patterns than the company agent that detects the current place as the company. In addition, the icon of the home agent is displayed more largely than the icon of the company agent. That is, the icon is output in the same shape 740 or in the size that varies depending on the number of times that the suitable usage pattern is extracted.

As another embodiment, the user may initially set the icon so that he/she directly inputs a frequently-visited place. When the usage record data that is previously connected to an external device at a current location of the mobile terminal 100 is present, an object corresponding to the external device is output on a background image corresponding to the current location.

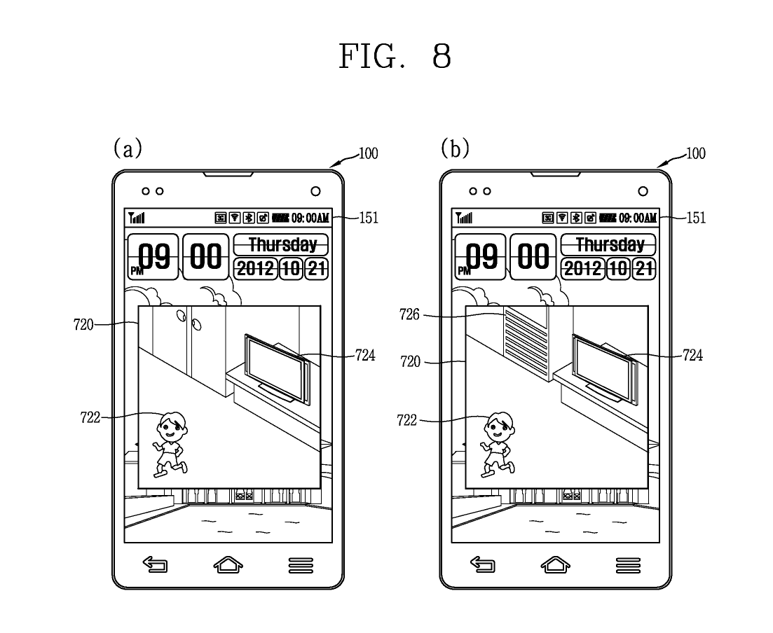

Next, FIGS. 8(a) and 8(b) are diagrams illustrating an embodiment of the user interface in which an object corresponding to an external device is output. Referring to FIG. 8(a), if the usage record data with which the mobile terminal 100 is frequently connected to a TV set in the home is present, an object 724 corresponding to the TV set is output on a background image 720 showing the room, along with the icon 722 of the home agent. When the user touches on the object 724 corresponding to the TV set, the mobile terminal 100 and the TV set are connected directly to the TV set.

Referring to FIG. 8(b), when the usage record data with which an air conditioner is repeatedly controlled in the home using the mobile terminal 100 is present, an object 726 corresponding to the air conditioner is added to a room image 720. When the user touches on the object corresponding to the air conditioner for selecting the object, a screen in which the air conditioner is controlled is output. That is, the objects 724 and 726 corresponding to the TV set and the air conditioner correspond to the items of information extracted by the agent, respectively.

As another embodiment, the user may directly set an object that he/she desires to output on the background image. That is, before the home agent begins learning, the object corresponding to the TV set or the air conditioner is set to be output on the background image showing the home. In addition, the already-output TV object is deleted by touching or dragging.

Further, the icon of the agent is continuously output to the display unit 151 or if a pre-set control command for requesting the icon of the agent is input, the icon of the agent is output to the display unit 151. For example, if the display unit 151 is double-tapped or the mobile terminal 100 is shaken, the icon of the agent is output, such as by holding the mobile terminal 100 in a grip.

In addition, each icon of the agent is requested in a different manner. For example, if the display unit 151 is double-tapped, the agent of the icon is requested, and if the mobile terminal 100 is shaken, an icon of a tour agent is requested.

As another embodiment, another icon of the agent may be output depending on the time when the control command is input and on the place where the control command is input. Specifically, if the display unit 151 is double-tapped, when the current location of the mobile terminal 100 is in the home, the icon of the home agent is output, when the current location of the mobile terminal 100 is in the company, the icon of the business agent is output.

In addition, if the display unit 151 is double-tapped, when the current time is a working time, the icon of the business agent is output, and when the current time is off-hour, the icon of the home agent is output.

As another embodiment, the agent may recognize situations, such as the time or the place and output the corresponding icon to the display unit 151. Specifically, the current location of the mobile terminal 100 is recognized as in the home, the icon of the home agent is automatically output.

If in this manner, the agent is output or the agent that is output is selected, an object corresponding to information that is extracted by the agent is output to the display unit 151. In addition, there are various embodiment of the object corresponding to the information extracted by the agent.

Specifically, the object corresponding to the information extracted by the agent is the message window 520 that asks whether or not to delete the message, which is described in FIG. 5 or the objects 724 and 726 corresponding to the TV set and the air conditioner described in FIG. 8.

As another embodiment, the object corresponding to the information extracted by the agent may include an icon of a specific application, an icon that when selected, executes a specific function of the mobile terminal 100 or switches to a specific mode, and so forth. As another embodiment, the tour agent may recognize from the stored schedule and the current location of the mobile terminal 100 that the user drives for touring Jejudo.

Accordingly, the icon of the tour agent is output as an icon that is automatically output to the display unit 151 and that switches a mode of the mobile terminal 100 to a driving mode. In addition, the mode of the mobile terminal 100 is automatically switched to the driving mode. As another example, an icon of an application that identifies delicious-food restaurants in Jejudo may be output.

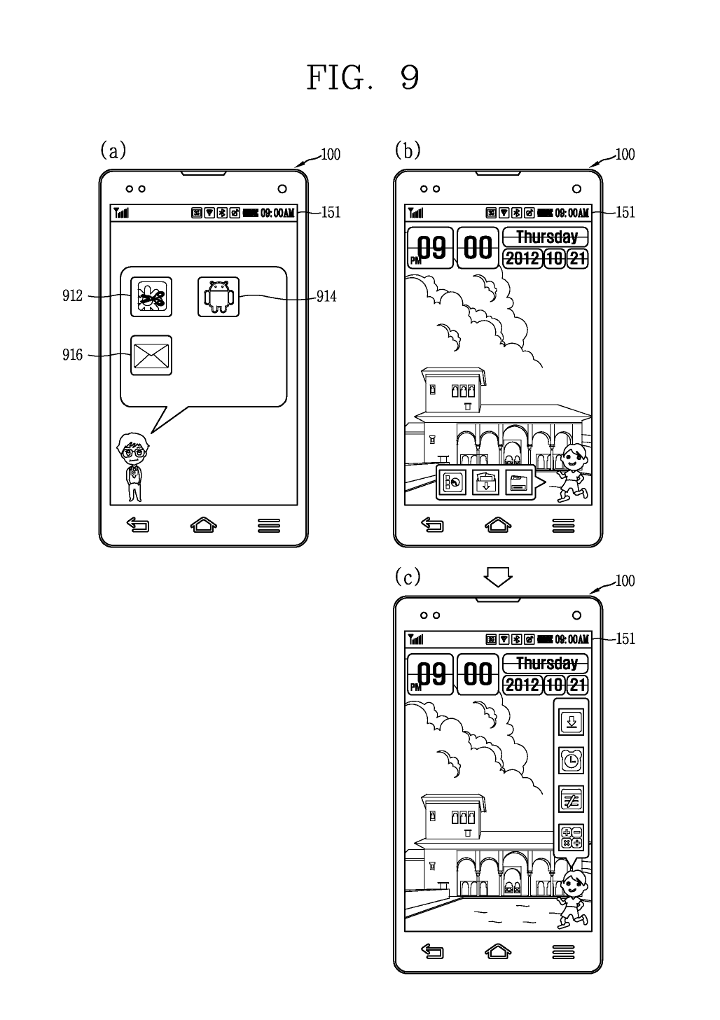

Next, FIGS. 9(a) to 9(c) are diagrams illustrating an embodiment of the user interface in which the object corresponding to the information extracted by the agent is output. In particular, FIG. 9(a) illustrates an embodiment in which an icon of an application corresponding to a usage pattern (information) extracted by a photo agent is output.

Referring to FIG. 9(a), the photo agent recognizes a usage pattern in which the user photographs his/her friends and then edits photographs and uploads or transmits the edited photographs to SNS or to his/her friends, and the like. Accordingly, the photo agent takes a photograph and then outputs an icon 912 of a photo editing application and an icon 914 of SNS to the display unit 151.

In addition, the photo agent recognizes faces of the user's friends included in the captured image and outputs an icon 916 of a messenger through which the user transmits or receives a message to and from his/her friends, to the display unit 151. That is, the agent reflects access to data being logged while using the application and thus proposes a function that the user is expected to use.

As another embodiment, the agent extracts an application that is frequently or recently used by the user, from the usage record data and outputs an icon corresponding to the extracted application to a home screen. Referring to FIG. 9(b), when the user touches on the icon of the agent, icons corresponding to applications that are frequently used by the user are output in the transverse direction. As a result, if the user touches on the icon that is output, the application corresponding to the icon is rightly executed.

Referring to FIG. 9(c), when the user applies a long touch to the icon of the agent in FIG. 9(b), icons corresponding to applications are output in the longitudinal direction. As another embodiment, the icon of the agent is double-tapped or the mobile terminal 100 is shaken, icons corresponding to applications are output in the longitudinal direction.

In addition, icons corresponding to applications other than the applications that are output in FIG. 9(b) may be output. For example, when the user applies the long touch to the icon of the agent in FIG. 9(b), icons of applications that are recently used or are set to be bookmarked are output in the longitudinal direction.

In addition, icons corresponding to applications are output differently depending on the current location of the mobile terminal 100. That is, if the agents are the same, different information is displayed depending on the location of the mobile terminal 100 that requests (calls) the agent.

For example, if the current location of the mobile terminal 100 in the company, icons corresponding to an email and office applications are output. In addition, if the current location of the mobile terminal 100 is in an auto vehicle, icons for executing a navigation function and a TTS function are output.

In addition, an object corresponding to information that is extracted by the sensor even though the display unit 151 is in an off state, recognizes voice information and detects the time, the place, and so forth is output. For example, even though the display unit 151 is in the off state, the current weather or time is output in the form of a voice.

Further, as illustrated in FIGS. 6(a) to 6(c), the icon of the agent is changed in the shape of a child who grows. As another embodiment, the icon of the agent expresses information that is currently detected, a function that is currently executed, and so forth.

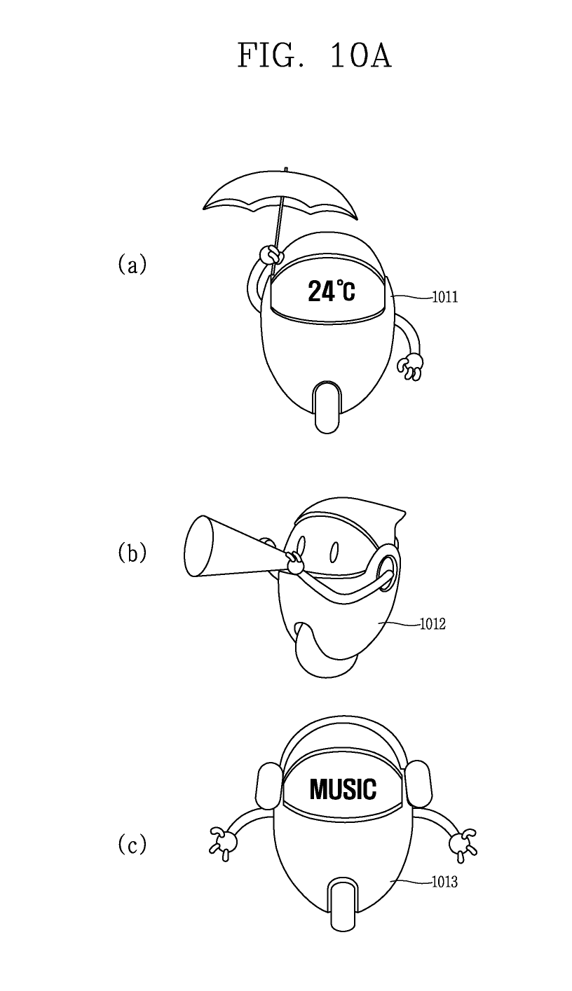

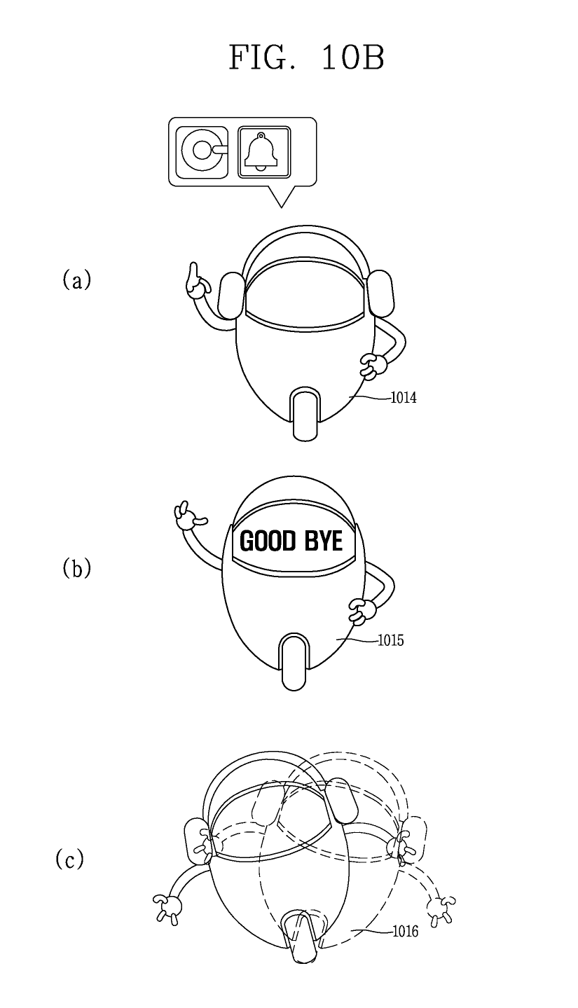

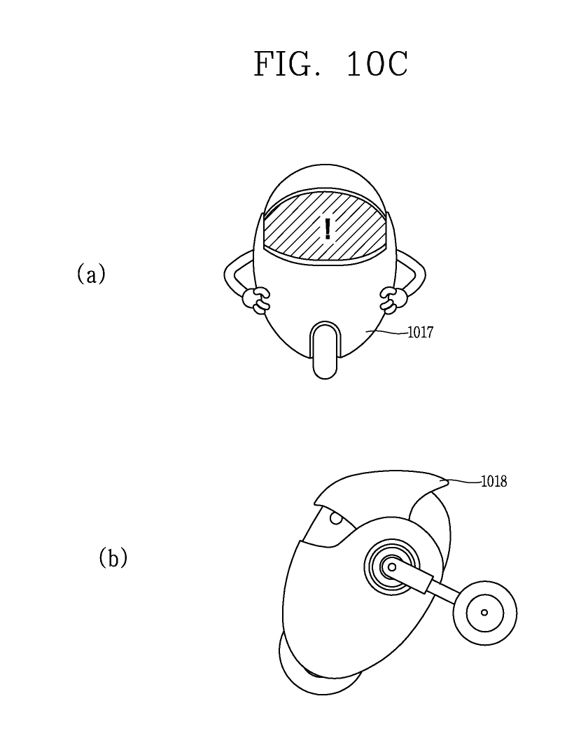

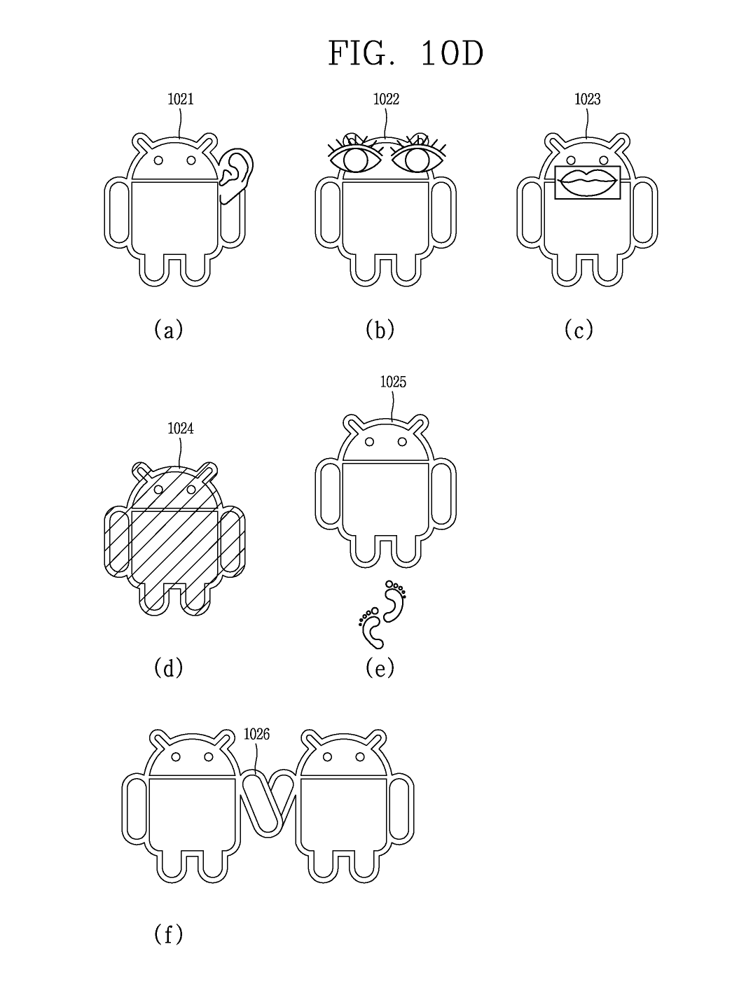

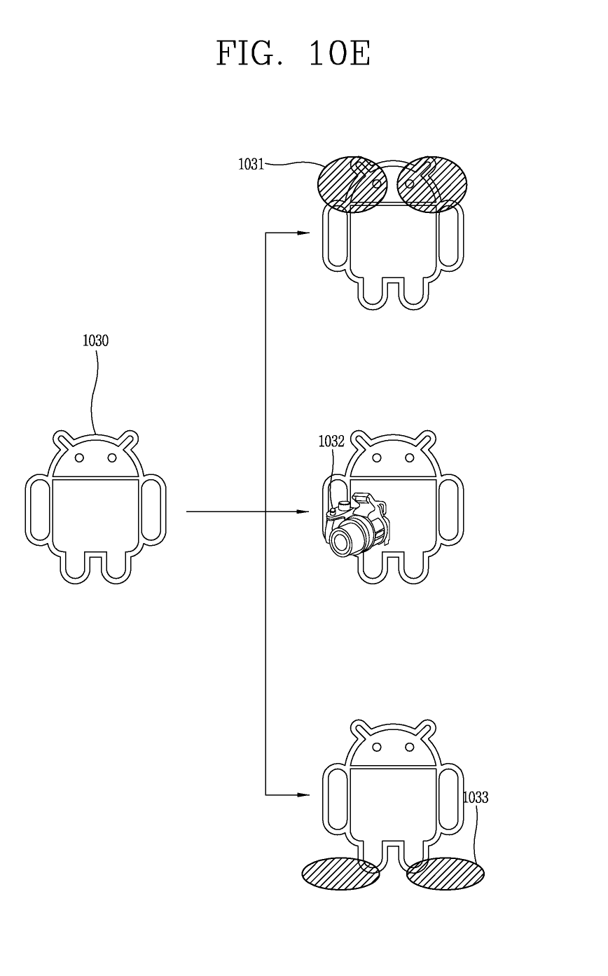

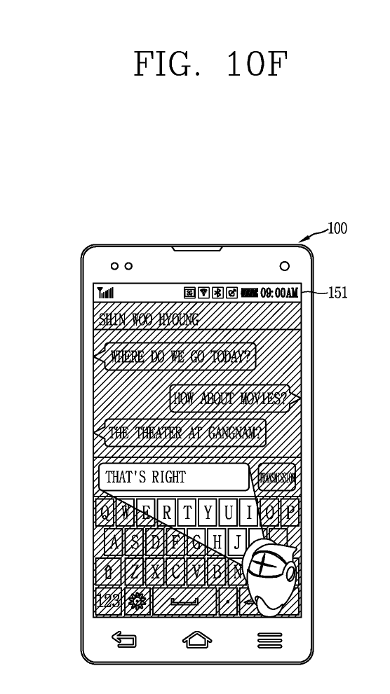

In particular, FIGS. 10A(a) to 10F and FIGS. 11A(a) to 11D are diagrams illustrating an embodiment of the user interface associated with the icon corresponding to the agent. The icon corresponding to the agent is expressed so that the information that is currently detected by the agent or the function is currently executed are intuitively recognized.

Referring to FIG. 10A(a), an icon 1011 of the agent intuitively expresses current weather conditions by wearing an item such as an umbrella, a parasol, or a hat. In addition, the current temperature is output on the face of the icon 1011. Referring to FIG. 10A(b), an icon 1012 of the agent executes an alarm function by outputting a shape that blows a bugle and the current time. Referring to FIG. 10A(c), if the user listens to music, an icon 1013 of the agent wears a headset item, a message (music) indicating that the user listens to music is output to the face of the icon 1013.

Referring to FIG. 10B(a), an icon 1014 of the agent proposes an icon of an application recommended to the user. In addition, the icon 1014 of the agent points to the icon of the recommended application.

Referring to FIG. 10B(b), if the mobile terminal 100 is terminated or a specific application that is being executed is terminated, a message (Good Bye) indicating the termination is output to the face of an icon 1015 of the agent that shakes its hand. Referring to FIG. 10B(c), if the music that the user frequently listens to is reproduced, an icon 1016 of the agent is output so as to move from left to right repeatedly to the rhythm of the music.

Referring to FIG. 10C(a), an icon 1017 of the agent expresses an emergency situation, such as when the mobile terminal 100 has low battery power or when the mobile terminal 100 is out of memory, by outputting an exclamation mark to the face of an icon 1017. In addition, a current situation is displayed with various detailed icons (indicating insufficient battery power and memory) instead of with the exclamation mark.

Further, when a recommendation or a notification is present, the face of the icon 1017 of the agent is output in a different color. For example, if the user misses an attached file in creating an email, the icon of the agent in the shape described above is output. Referring to FIG. 10C(b), if it takes long time to process a lot of data, an icon 1018 of the agent in the shape of a running horse is output.

As another embodiment, referring to FIG. 10D(a), when executing a voice recognition application, an ear portion of an icon 1021 of the agent is output in an emphasized manner. Referring to FIG. 10D(b) and 10D(c), when executing an OCR application, an eye portion of an icon 1022 of the agent is output in an emphasized manner and when executing a TTS application, an mouth portion of an icon 1023 of the agent is output in an emphasized manner.

In addition, the ear, eye, and mouth portion of each of the icons of 1021, 1022, and 1023 of the agent are displayed more largely than the other portions or are displayed in different colors in an emphasized manner.

Referring to FIG. 10D(d), if the agent detects ambient temperature, an icon 1024 of the agent is output in a different color. Referring to FIG. 10D(e), the agent executes a pedometer application, footmarks of an icon 1025 of the agent are displayed to indicate executing of the pedometer.

Referring to FIG. 10D(f), if the mobile terminal 100 transmits and receives data to and from an external mobile terminal, two icons 1026 that holds each other's hand indicates the data transmission and reception between the two mobile terminal. In addition, the agent is set to perform a specific function, by adding a specific item to the icons of the agent described above.

Referring to FIG. 10E, if tour eye glasses 1020 such as sun glasses are attached to a basic icon of the agent, the agent continuously displays delicious-food restaurant information and traffic information while the user is on the move. As another embodiment, if a camera 1032 is attached to a basic icon 1030 of the agent, the agent automatically takes a photograph at predetermined time intervals or at arbitrary time.

Accordingly, paths along which the user moves during tour, and situations that the user faces during tour are grasped. As another embodiment, if shoes 1033 are attached to the basic icon 1030 of the agent, a gyro sensor of the agent operates and stores details of the user's exercise. A mode in which the icon of the agent is edited is entered and this specific item is selected for addition.

As another embodiment, referring to FIG. 10F, only a portion of a message that the user is creating is brightly displayed through the use of an icon of the message agent. Accordingly, privacy of the user is protected. In addition, only a portion of the message that is being created is output enlargedly or in a different color, and thus the user can easily recognize the portion.

As another embodiment, when the user reads a web page or a document, if a word in which the user is interested is detected, the word may be displayed brightly as described above. In addition, if the user clicks on the word in which he/she is interested, the web is searched for the user-interested word, or the user-interested word is connected to a specific link.

In addition, if the icon of the agent is output to the display unit 151, the icon of the agent occupies given space. As a result, the icon of the agent covers other details that are output on the display unit 151.

An embodiment is described below in which the icon of the agent is efficiently arranged on the display unit 151. As an embodiment, the user may request (call) a memo agent while reading the document. In addition, if the memo agent is not needed for the user to read pages or if the details of the document occupy the whole display unit 151, an icon of the memo agent covers the details of the document, because the memo agent is requested and then is not used for a long time, resulting in a waiting time becoming longer.

To solve this problem, the icon of the memo agent is output in the manner illustrated in FIGS. 11A(a) to 11A(c). Referring to FIG. 11A(a), an icon 1110 of the memo agent is output along with a transparent-image effect. For example, as the waiting time when the agent is used is longer, the icon is more transparent or the shape of the icon is displayed with only a dotted line. In addition, if the user calls the agent by voice, the icon is denser and denser and returns to its original shape.

Referring to FIG. 11A(b), an icon 1120 of the memo agent is output to the edge of the display unit 151 so as not to cover the details of the document. In addition, only a portion of the icon 1120 of the memo agent is output. Referring to FIG. 11A(c), as the waiting time is longer, the size of an icon 1130 of the memo agent is more reduced.

Referring to FIG. 11B, if the icon of memo agent is output on the document, the details of the document is output in a state where a region to which the icon of the memo agent is output is unoccupied. That is, the background screen to which the icon is output is edited and thus is output.

Referring to FIG. 11C, an icon 1140 of the agent covers the photo or the text information that is output to the display unit 151, the overlapping object is detected and thus the icon 1140 of the agent is moved to an empty region of the display unit 151. Referring to FIG. 11D, an icon 1150 of the called agent is temporarily hidden and thus the user convenience is improved. That is, if reproducing of moving images is adjusted, the icon 1150 of a moving image agent is output, and if the moving images are reproduced, the icon 1150 of the moving image agent is hidden.

As another embodiment, the icon of the agent may be output in the 3D form as if the icon of the agent floated in the air. In addition, the icon of the agent is output along with a transparent-image effect.

In addition, an embodiment of a process is described in which the agent extracts the related information from the usage record data. As an embodiment, if the mobile terminal 100 is connected to a charging cable for a given time, the agent may extract the related information. In addition, the place where the charging is performed is recognized and thus is set to be the background of the icon of the agent described in FIGS. 7A to 7D.

As another embodiment, if specific information is input, the agent associated with the specific information is executed for a given time. The specific information that is input includes text information, payment information, and the like. For example, if the user searches for raw food sources, when the current location of the mobile terminal 100 is recognized as near a mart, the message window indicating that the mobile terminal 100 is near the mart is output.

In addition, when the location of the mobile terminal 100 is recognized as a mart where the payment is frequently made, the message window indicating that the mobile terminal 100 is near the mart where the payment is frequently made is output. Further, as described above, the agent edits the agent information, by deleting a selected portion of the extracted information or by adding a newly-input information to the extracted information.

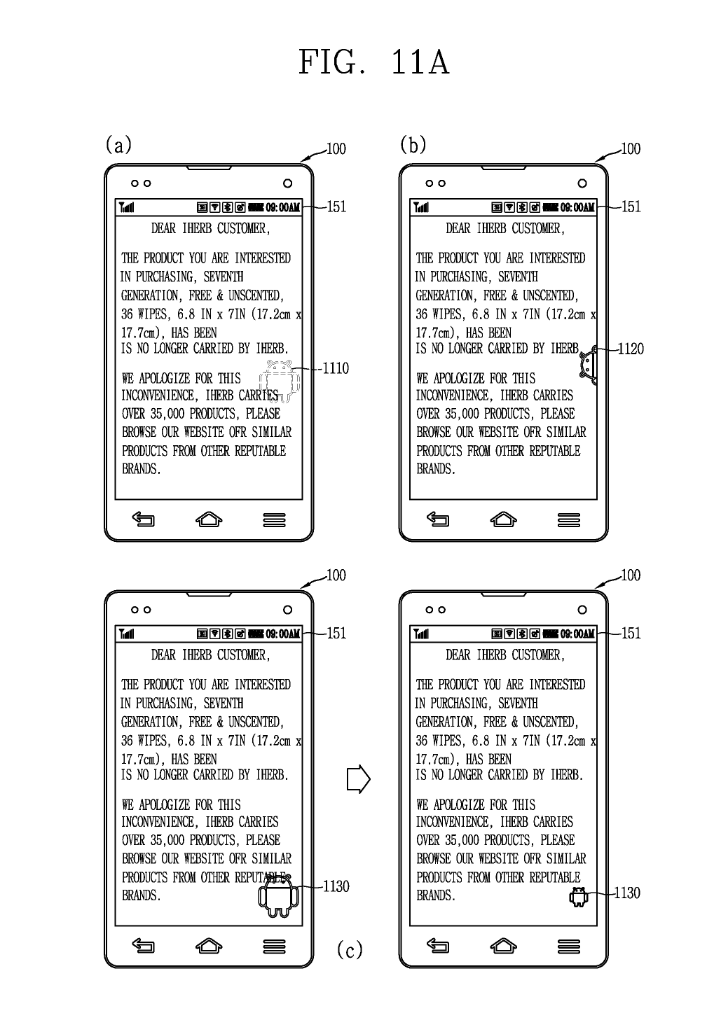

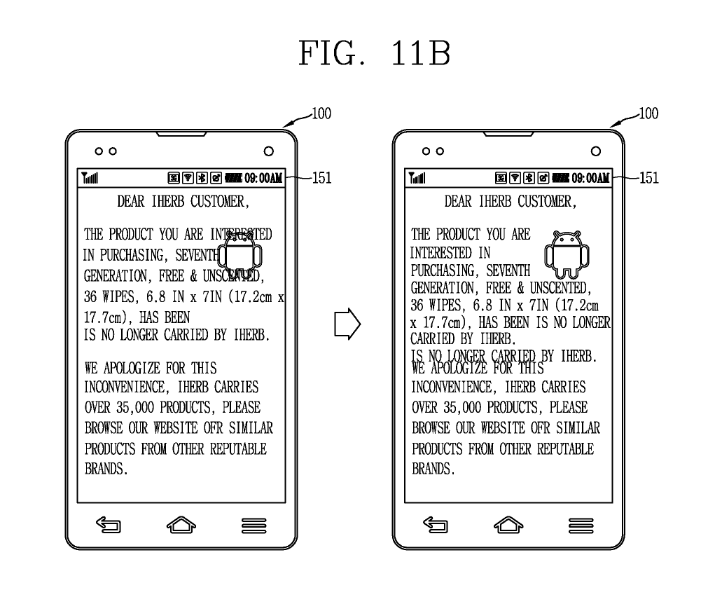

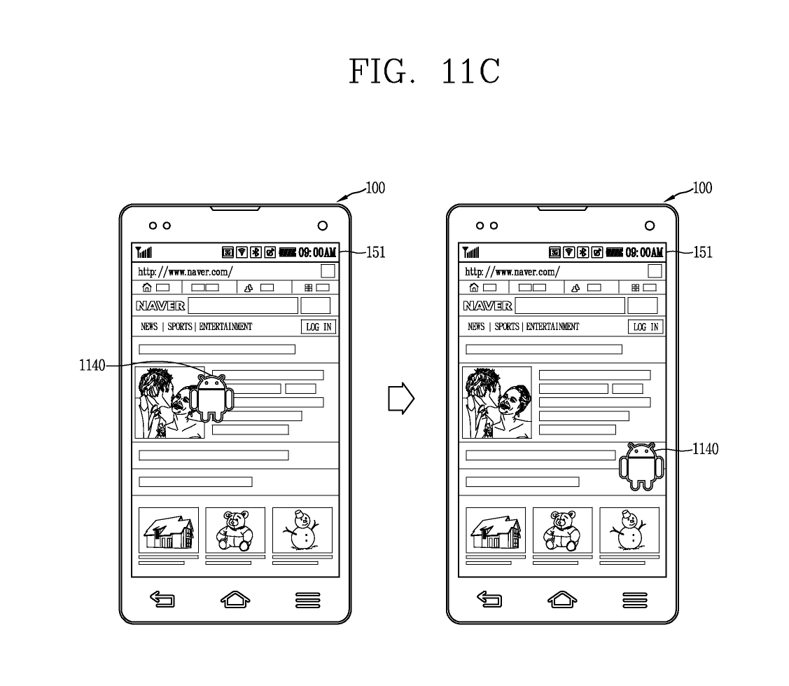

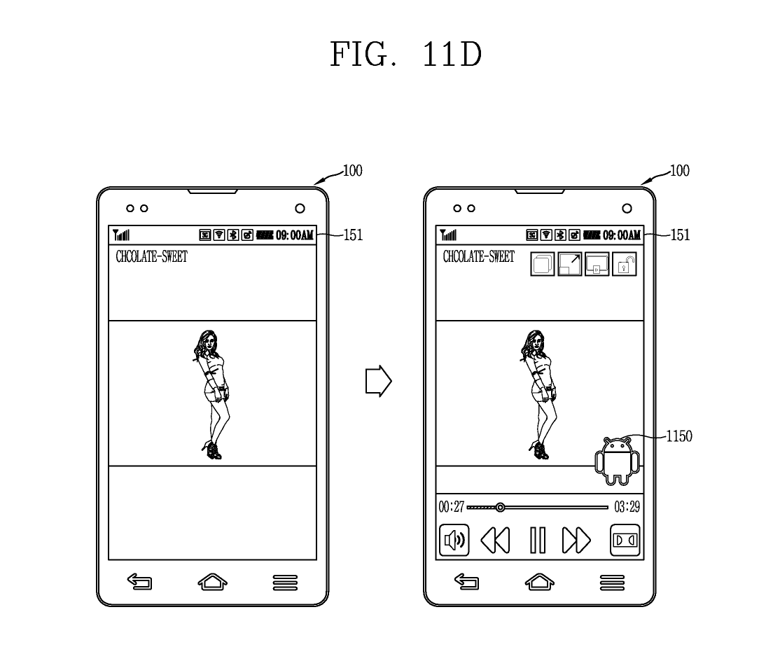

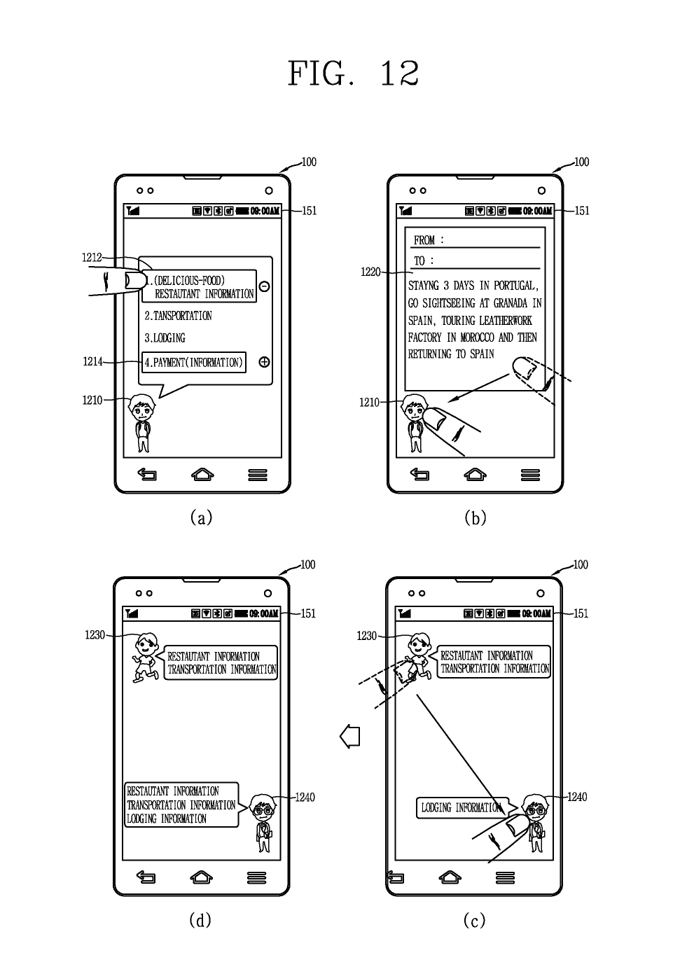

FIGS. 12(a) to 12(d) are diagrams illustrating an embodiment of the user interface in which the extracted information is edited. Referring to FIG. 12(a), items of information that are extracted by the tour agent are output in the editing mode in which the tour agent is edited.

At this point, the user can select an icon 1212 corresponding to first information by touching on an icon 1212. In addition, when the long touch is applied to the icon 1212 of the first information, an icon 1210 of the tour agent is changed to the shape of a wastebasket. Thereafter, the icon 1212 of the first information is deleted by dragging the icon 1212 to an icon in the shape of a wastebasket.

In addition, new second information is input as tour agent information. For example, the second information is added as the tour agent information by directly inputting the second information or dragging an icon 1214 corresponding to the second information.

Referring to FIG. 12(b), an email 1220 received associated with the tour is dragged to the icon 1210 of the tour agent. Accordingly, details 1220 of the received email are input as the tour agent information.

Referring to FIGS. 12(c) and (d), if icons 1230 and 1240 of the first and second agents are output at the same time, the icon 1230 of the first agent is dragged to the icon 1240 of the second agent. Accordingly, information extracted by the first agent is added to second agent information.

In addition, the second information agent is replaced with first agent information. As another embodiment, the first agent information and the second agent information are compared and then recently-updated information is selected to be set to be the second agent information. Further, the agent transmits only selected information among the items of information to the external device connected to the mobile terminal 100. Specifically, the information is transmitted to and received from the agent that is present in the external device.

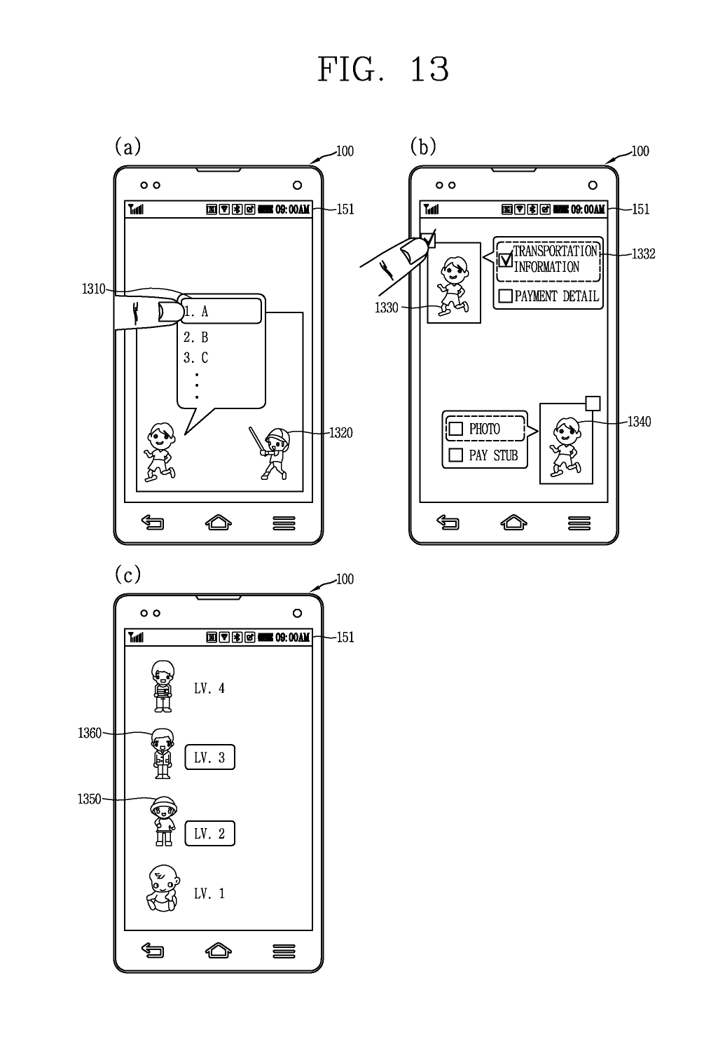

FIGS. 13(a) to 13(c) are diagrams illustrating an embodiment of the user interface associated with the agent that is present in the external device. Referring to FIG. 13(a), if the user selects one friend 1310 from among his/her registered friends, an icon 1320 of an agent of the selected friend is displayed on the mobile terminal 100. In addition, the icon 1320 of the agent of the friend expresses a current state of the friend.

For example, when the friend is taking exercise, an icon 1320 of an exercise agent of the friend is displayed on the mobile terminal 100. As another embodiment, the use may have a chat with the called friend in real time through the icon of the agent of the called friend.

As another embodiment, if the mobile terminal of the registered friend is positioned within a pre-set distance, the icon of the agent of the friend may be automatically output. To do this, the agent checks whether a Wi-Fi or BT connection is available within a given radius.

In addition, when an icon of the agent of the friend that is output is touched on, the information corresponding to the touched-on icon is transmitted to the agent of the user. Further, only the information that is pre-set to be allowed to be transmitted is transmitted.

Referring to FIG. 13(b), the agent or the information included in the agent, which the user desires to share with his/her friend, is selected. Specifically, an icon 1330 of the first agent is touched on for selection. Accordingly, only the information included in the first agent corresponding to the first icon 1330 selected from among the icon 1330 of the first agent and an icon 1340 of the second agents is shared. In addition, only information 1332, one item of information selected from among items of information included in the first agent, is selected for sharing.

Referring to FIG. 13(c), only information included in an agent corresponding to a level selected from levels, each indicating the extent of learning, is shared. Specifically, for the first agent, as an amount of learned information is more increased, the level rises up.

Accordingly, if the first agent is categorized into the first to fourth levels, the user can select icons 1350 and 1360 of the agents corresponding to the second and third levels. As a result, only information included in an agent corresponding to the selected first and second levels is shared with other people.

As another embodiment, when the user flicks the icon of the agent toward the current location of the mobile terminal to which the user desires to switch, the corresponding agent may be transmitted. Accordingly, even though the mobile terminal is changed, the agents that are used in the previous mobile terminal are used in a new mobile terminal as well.

As another embodiment, the agents may be shared with more people, such as by sharing through SNS. As another embodiment, a security agent may detect that a pattern in which a locked screen of the mobile terminal 100 is unlocked is input a predetermined number of times or above, that the batter is detached although the battery power is sufficient, and so forth. Accordingly, the security agent actively backs up data in a cloud server and temporarily deletes personal information stored in the mobile terminal 100. In addition, the security agent may notify an acquaintance of a security-at-risk situation.

According to embodiments of the present invention, a more convenient interface is provided to the user because the agent extracts, by itself, the information relating to the key word that is set, and does learning. In addition, a more individual agent service is provided to the user, such as by adding or deleting the agent information.

Then, the information that is desired to be shared with other people is selectively set and thus personal information is protected and at the same time various items of information are provided. As a result, the user convenience is improved.

In addition, according to one embodiment disclosed in the present specification, the method described above may be realized by being stored as processor-readable codes in a program-stored medium. A ROM, a RAM, a CD-ROM, a magnetic tape, a floppy disk, an optical data storage device and the like are examples of the processor-readable medium, and the processor-readable medium may be realized in the form of a carrier wave (for example, a transmission over the Internet).

With regard to the mobile terminal described above, the configuration and method of the embodiments described above are not given any limitation to their applications, and all of, or some of the embodiments may be selectively combined with each other in a manner that creates various modifications.

The foregoing embodiments and advantages are merely exemplary and are not to be considered as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a wireless communication unit configured to perform wireless communication;
a display unit configured to display information; and
a controller configured to:
execute an agent to extract and record information about a usage pattern of a user, and
display an icon corresponding to the executed agent differently based on a number of times information related to the executed agent is extracted.

2. The mobile terminal of claim 1, wherein the usage pattern corresponds to at least one of 1) an action of the user performed on the mobile terminal, 2) a schedule of the user included on the mobile terminal, and 3) an exercise pattern of the user.

3. The mobile terminal of claim 2, wherein the action performed on the mobile terminal includes a delete function when an particular event occurs on the mobile terminal and the extracted information corresponds to a preset keyword, and
wherein when the particular event occurs again on the mobile terminal, the controller is further configured to display an object in association with the icon prompting the user to again perform the delete function.

4. The mobile terminal of claim 2, wherein the action performed on the mobile terminal includes a set schedule, and
wherein when the user is scheduled to attend the set schedule, the controller is further configured to play a multimedia file in association with the icon.

5. The mobile terminal of claim 2, wherein the controller is further configured to display the icon as changing in shape to indicate a recently performed exercise pattern of the user.

6. The mobile terminal of claim 1, wherein the controller is further configured to display the icon differently to identify when the mobile terminal is at a first place then when the user is at a second place different than the first place.

7. The mobile terminal of claim 6, wherein the first place includes a home of the user and the second place includes a work place of the user.

8. The mobile terminal of claim 1, wherein the controller is further configured to display a background screen with the icon corresponding to currently extracted information.

9. The mobile terminal of claim 8, wherein the controller is further configured to display an object on the background screen corresponding to the currently extracted information.

10. The mobile terminal of claim 1, wherein the controller is further configured to execute a predetermined function corresponding to the extracted information.

11. The mobile terminal of claim 10, wherein the predetermined function includes at least one of 1) turning on or off an appliance, and 2) executing an application on the mobile terminal corresponding to the extracted information.

12. The mobile terminal of claim 1, wherein the controller is further configured to differently display the icon based on a location of the mobile terminal.

13. The mobile terminal of claim 1, wherein when the usage pattern indicates the mobile terminal is frequently connected to an appliance, the controller is further configured to display an object representing the appliance on a background screen, and
wherein when the displayed object is selected, the controller is further configured to wirelessly connect to the appliance.

14. The mobile terminal of claim 1, wherein the icon identifies the agent and has a human shape.

15. The mobile terminal of claim 1, wherein the agent is a photo agent, and when the usage pattern indicates an editing or uploading of photographs on the mobile terminal, the photo agent displays icons for executing editing or uploading of a photograph near the photo agent when the photograph is captured.

16. The mobile terminal of claim 15, wherein the controller is further configured to recognize a face in the captured photograph, and display a messenger icon near the photo agent for messaging a counterpart user corresponding to the recognized face.

17. The mobile terminal of claim 1, wherein the agent transmits only information selected from among items of information extracted by the agent to an external device that is connected to the mobile terminal.

18. The mobile terminal of claim 17, wherein the agent is categorized into multiple levels, depending on the number of times that the information is extracted, and transmits only information corresponding to at least one level selected from among the multiple levels to the external device.

19. A method of controlling a mobile terminal, the method comprising:
display, via a display unit of the mobile terminal, a background screen or an execution screen;
executing, via a controller of the mobile terminal, an agent to extract and record information about a usage pattern of a user; and
displaying, via the display unit, an icon corresponding the executed agent differently based on a number of times information related to the executed agent is extracted.

20. The method of claim 1, wherein the usage pattern corresponds to at least one of 1) an action of the user performed on the mobile terminal, 2) a schedule of the user included on the mobile terminal, and 3) an exercise pattern of the user.
